(19) United States
(12) Patent Application Publication
(10) Pub. No.: US 2025/0355271 A1
(43) Pub. Date: Nov. 20, 2025

(54) PORTABLE AIR FLOATING VIDEO DISPLAY APPARATUS

(71) Applicant: Maxell, Ltd., Kyoto (JP)

(72) Inventors: Koji HIRATA, Kyoto (JP); Toshinori SUGIYAMA, Kyoto (JP)

(73) Assignee: Maxell, Ltd., Kyoto (JP)

(21) Appl. No.: 18/997,856

(22) PCT Filed: Jun. 2, 2023
(86) PCT No.: PCT/JP2023/020644

§ 371 Date: Jan. 23, 2025

(30) Foreign Application Priority Data
Jul. 27, 2022 (JP) 2022-119947

(51) Int. Cl. G02B 30/56; G02B 5/12

(52) U.S. Cl. CPC G02B 30/56; G02B 5/12

(57) ABSTRACT

A video is preferably displayed on outside of a space. The present invention contributes to “the third goal: Good Health and Well-being (for all people)”, “the ninth goal: Industry, Innovation and Infrastructure” and “the eleventh goal: Sustainable Cities and Communities” of the sustainable development goals. An air floating video display system includes: a housing holding a display panel and a light source; a power supply including a power source and being joined with the housing through a first joint; and a flame structure holding a retroreflector movably joined with the housing through a second joint.

### TECHNICAL FIELD

The present invention relates to a portable air floating video display system and an optical system used therefor.

### BACKGROUND ART

A video display configured to directly display a video toward outside and a display method of displaying it as an air (space) screen have been already known as an air floating video display system. Also, a retroreflector configured to display an air image has been disclosed in, for example, a Patent Document 1. Further, this has been disclosed in, for example, a Patent Document 2.

### RELATED-ART DOCUMENT

### Patent Document

Patent Document 1: Japanese Patent Application Laid-open Publication No. 2017-067933

Patent Document 2: Japanese Patent Application Laid-open Publication No. 2019-133109

### SUMMARY OF THE INVENTION

### Problems to be Solved by the Invention

A video display configured to directly display a video toward outside and a display method of displaying it as an air (space) screen have been already known as an air floating video display system. However, regarding the related-art air floating video apparatus, the documents describe the configuration and the arrangement of the retroreflector forming the air floating video and the method of emitting the video light from the light source, but do not take into account a configuration of a portable air floating video display system and a technique for achieving this.

An objective of the present invention relates to an air floating video display system or an air floating video display apparatus, and is to provide a technique capable of achieving a portable air floating video display system.

### Means for Solving the Problems

In order to solve the problems, for example, configurations described in a section <CLAIMS> are employed. The present application includes a plurality of means for solving the above problems, and an air floating video display apparatus as one of the means will be exemplified below. An air floating video display system as one example of the present application includes: a housing holding a display panel and a light source; a power supply including a power source and joined with the housing through a first joint; and a frame structure holding a retroreflector movably joined with the housing through a second joint.

### Effects of the Invention

According to the present invention, a portable system of an air floating video display system or air floating video display apparatus can be achieved. Other issues, configurations and effects than those described above will be apparent from the explanation for the following embodiments.

### BRIEF DESCRIPTIONS OF THE DRAWINGS

FIG. 1A is a diagram illustrating a configuration of a transmission-type retroreflector and a formation position of an air floating image according to one embodiment of the present invention.

FIG. 1B is an explanatory diagram for explaining a property of an optical member configuring a transmission-type retroreflector according to one embodiment of the present invention.

FIG. 2 is a diagram illustrating a configuration of a reflection-type retroreflector and a formation position of an air floating image according to one embodiment of the present invention.

FIG. 3 is a configuration diagram illustrating an exemplary specific configuration of a liquid crystal panel according to one embodiment of the present invention.

FIG. 4 is a configuration diagram illustrating arrangement of a light source and a liquid crystal panel according to one embodiment of the present invention.

FIG. 5 is a side view illustrating a configuration of an air floating video display system according to one embodiment of the present invention.

FIG. 6 is a top view illustrating a configuration of an air floating video display system according to one embodiment of the present invention.

FIG. 7 is a second side view illustrating a configuration of an air floating video display system according to one embodiment of the present invention.

FIG. 8 is a third side view illustrating a configuration of an air floating video display system according to one embodiment of the present invention.

FIG. 9 is a fourth side view illustrating a configuration of an air floating video display system according to one embodiment of the present invention.

FIG. 10 is a first front view illustrating a configuration of an air floating video display system according to one embodiment of the present invention.

FIG. 11 is a fifth side view illustrating a configuration of an air floating video display system according to one embodiment of the present invention.

FIG. 12 is a second front view illustrating a configuration of an air floating video display system according to one embodiment of the present invention.

FIG. 13A is a diagram illustrating a configuration of an air floating video display system according to one embodiment of the present invention.

FIG. 13B is a perspective view illustrating a configuration of an air floating video display system according to one embodiment of the present invention.

FIG. 13C is a front view illustrating a configuration of an air floating video display system according to one embodiment of the present invention.

FIG. 13D is a configuration diagram illustrating a transparent-view part of a housing in a top view illustrating a configuration of an air floating video display system according to one embodiment of the present invention.

FIG. 13E is a side view illustrating a configuration of an air floating video display system according to one embodiment of the present invention.

FIG. 13F is a diagram illustrating a configuration of an air floating video display system according to one embodiment of the present invention.

FIG. 14 is a perspective view, a top view, and a cross-sectional view illustrating an exemplary specific configuration of the light source.

FIG. 15A is a configuration diagram illustrating another exemplary specific configuration of the light source of another mode.

FIG. 15B is a diagram illustrating an extracted part of another exemplary specific configuration of the light source of another mode.

FIG. 15C is a diagram illustrating an extracted part of another exemplary specific configuration of the light source of another mode.

FIG. 15D is a diagram illustrating an extracted part of another exemplary specific configuration of the light source of another mode.

FIG. 16A is a configuration diagram illustrating another exemplary specific configuration of the light source of another mode.

FIG. 16B is a diagram illustrating another exemplary specific configuration of the light source of another mode.

FIG. 17 is a cross-sectional view illustrating an exemplary specific configuration of a diffuse plate including a light source.

FIG. 18 is an explanatory diagram for explaining a diffuse property of the video display.

FIG. 19 is an explanatory diagram for explaining a diffuse property of the video display.

FIG. 20 is a diagram illustrating a coordinate system for measuring visual property of a liquid crystal panel.

FIG. 21 is a diagram illustrating luminance angle property (long-side direction) of a typical liquid crystal panel.

FIG. 22 is a diagram illustrating luminance angle property (short-side direction) of the typical liquid crystal panel.

FIG. 23 is a diagram illustrating contrast angle property (long-side direction) of the typical liquid crystal panel.

FIG. 24 is a diagram illustrating contrast angle property (short-side direction) of the typical liquid crystal panel.

### DETAILED DESCRIPTION OF PREFERRED EMBODIMENTS

Hereinafter, embodiments of the present invention will be explained in detail with reference to the drawings. Note that the present invention is not limited to contents of embodiments (also referred to as “present disclosure”) explained below. The present invention also covers the invention's spirit, the scope of the technical idea described in claims, or equivalents. The configuration of the embodiments (examples) explained below is only one example, and can be variously modified and altered within the scope of the technical idea disclosed in the present specification by the person skilled in the art.

The components having the same or similar function are denoted with the same reference sign through the drawings for explaining the present invention, and the different name is appropriately used. On the other hand, the repetitive explanation for the function and others may be omitted. In the following explanation for the embodiments, note that the floating image in air is expressed as a term “air floating video”. In place of this term, this may be expressed as “air (aerial) image”, “spatial image”, “air floating video”, “air floating optical image of display image”, “spatial floating optical image of display image” or others. The term “air floating video” mainly used in the explanation for the embodiments is used as a typical example of these terms.

The present disclosure relates to a portable information terminal or the like capable of displaying a video based on video light emitted from a small video-light source, as an air floating video by using a retroreflector.

According to the following embodiments, for example, high-resolution video information can be displayed above a glass surface of a show window or a light-transmittable plate member while floating in air. In this case, only normal reflection light can be efficiently reflected with respect to the retroreflector by making a divergence angle of the emitted video light small, that is, be an acute angle, and unifying the video light to have a specific polarized wave. Therefore, the light use efficiency is high, and a portable small air floating video display apparatus having low power consumption that cannot be achieved by a related-art retroreflection method can be provided.

An apparatus and an optical system including the light source of the present disclosure can significantly reduce power consumption, and can provide an air floating video display system that is portable under low power consumption, when being combined with a novel small video display (liquid crystal panel). A technique of the present disclosure can provide, for example, an in-vehicle floating video display system being capable of displaying a visually-recognizable, that is, unidirectionality air floating video outside a vehicle through a shield glass including a front windshield glass, a rear windshield glass and a side windshield glass of the vehicle.

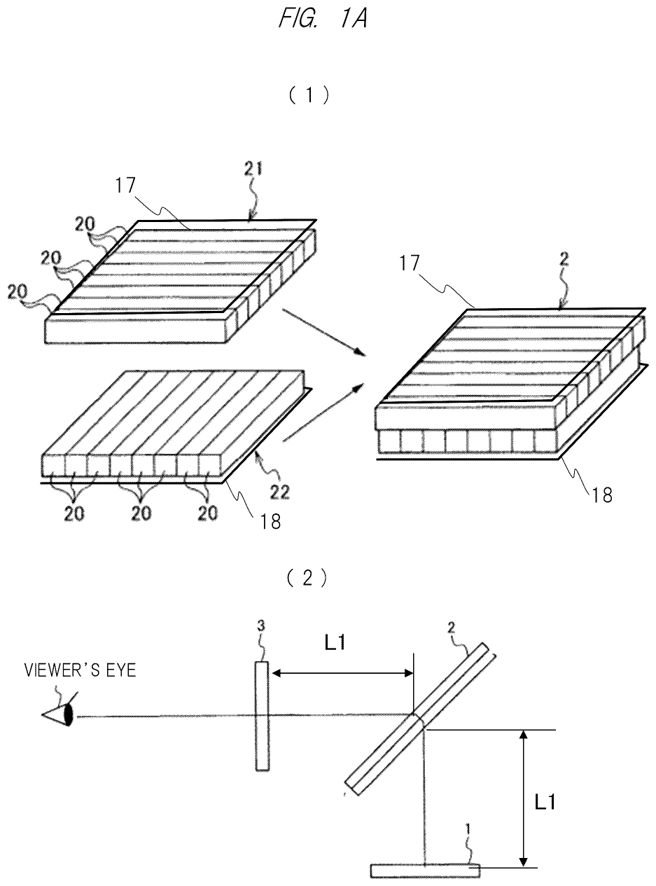

Next, a function of the transmission-type retroreflector used in the air floating video display apparatus of an example disclosed in the present application and an example of a specific air floating video display apparatus will be explained. As illustrated in FIG. 1A(2), generally, the transmission-type retroreflector 2 tilts by an angle of 40 to 50 degrees from the video display 1. In this case, from the transmission-type retroreflector 2, the air floating video 3 is emitted at the same angle with the incident angle of the video light on the transmission-type retroreflector 2. In this case, the air floating video 3 is formed at a position symmetrical to a position distant by the same distance L1 between the video display 1 and the transmission-type retroreflector 2.

A mechanism of the image formation of the air floating video using the optical system based on the transmission-type retroreflector 2 illustrated in FIGS. 1A and 1B will be explained in detail with reference to FIGS. 1A and 1B. The video light emitted from the video display 1 provided on one of the transmission-type retroreflectors 2 is reflected on a planar-light reflector C of a second light controller 22 (a reflection surface of a light reflector 20), and then, is reflected on a planar-light reflector C′ of a first light controller 21 (a reflection surface of the light reflector 20), thereby forming the air floating image (real image) 3 at a position outside the transmission-type retroreflectors 2 (the position being on the other side space). That is, the air floating video display apparatus is achieved by the transmission-type retroreflectors 2, and the image of the video display 1 can be aerially displayed as the air floating image.

Since the above-described transmission-type retroreflector 2 has the two reflection surfaces as described above, the two ghost images 3a and 3b depending on the number of reflection surfaces are formed in addition to the air floating image 3 as illustrated in FIGS. 1B(1) and (2).

Further, as a problem, it has been found that entering of high-intensity external light from the top surface of the transmission-type retroreflector 2 makes an interval (300 μm or less) between the reflection surfaces short, and therefore, causes optical interference to be observed as iridescent-color reflection light, and makes the presence of the retroreflector recognizable for the viewer. Thus, an area of a place where the interference light is formed has been experimentally found while taking an incidence angle of the external light as a parameter to prevent the interference light from returning to the viewer, the interference light being formed by the incident external light at the pitch of the reflection surface of the retroreflector 5. It has been found that, in setting in which the pitch between the reflection surfaces is 300 μm while a height of the reflection surface is 300 μm, the interference light does not return to the viewer when the transmission-type retroreflector tilts by a tilt angle θYZ of 35 degrees or more from a vertical surface.

On the other hand, at a ratio (H/P) between the pitch P between the light reflectors 20 and the height H of the reflection surface, it has been found that about 60% of the reflection surface forms the air floating image based on the retroreflection while the remaining 40% thereof forms the abnormal reflection light forming the ghost images. The pitch of the reflection surfaces absolutely needs to be reduced in order to improve resolution of the air floating video in the future. Additionally, the ratio (H/P) between the pitch P of the reflection surfaces and the height H thereof may be selected between 0.8 and 1.2 instead of the current ratio of 1.0 due to limitations in manufacturing the second retroreflector 2 although the height of the reflection surface needs to be higher than the current height in order to suppress the formation of the ghost images.

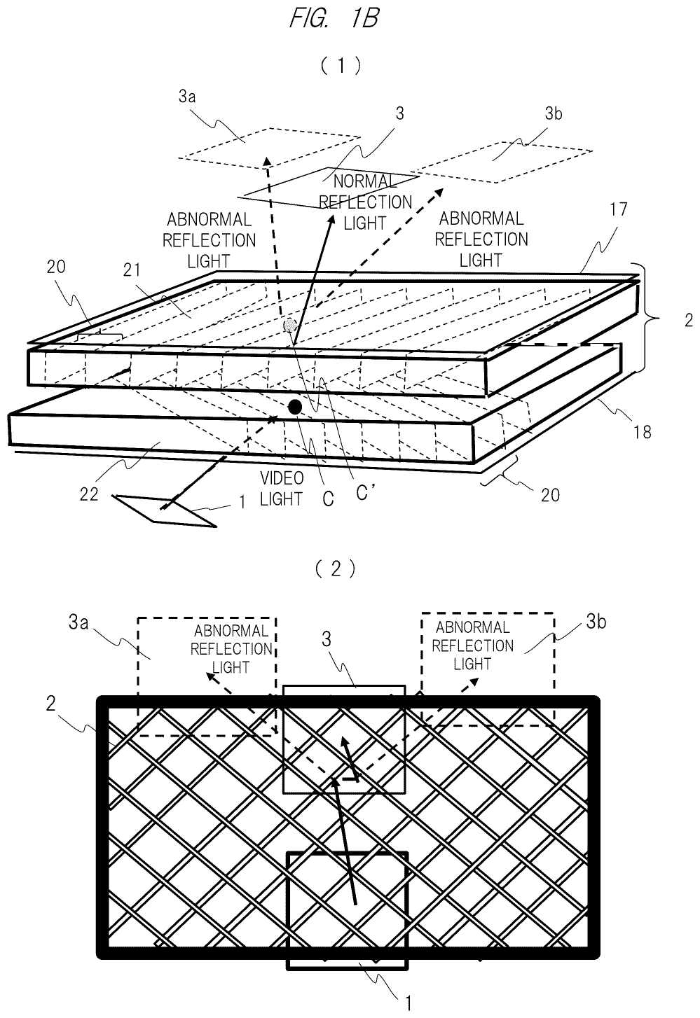

FIG. 2 illustrates a configuration of a reflection-type retroreflector and a basic configuration of the air floating video display apparatus using the reflection-type retroreflector according to one embodiment of the present invention. As illustrated in FIG. 2, the air floating video display system includes the video display 1 that diverges the video light of the specific polarization wave at a narrow angle toward an oblique direction with respect to a transparent member or a light-transmittable plate 100 such as glass having transmittance. The video display 1 includes a liquid crystal display panel 11 and a light source 13 that generates the light of the specific polarization wave having the narrow divergence property.

The video light of the specific polarization wave emitted from the video display 1 is reflected by a polarization splitter 101 provided on the transparent member 100 and having a film that selectively reflects the video light of the specific polarization wave (in the drawing, the sheet-shaped polarization splitter 101 is adhered the transparent member 100), and the reflection light is made incident on the retroreflector 5. A video-light entering surface of the retroreflector 5 is provided with a λ/4 plate 21. The video light is converted in terms of light polarization from the specific polarization wave (one polarization wave) to the other polarization wave when being transmitted through the λ/4 plate 21 twice in total that are the entering to and the emission from the retroreflector 2. Here, the polarization splitter 101 that selectively reflects the video light of the specific polarization wave has a property of transmitting the polarization-converted video light of the other polarization wave. Therefore, the polarization-converted video light of the other polarization wave is transmitted through the polarization splitter 101. The video light having been transmitted through the polarization splitter 101 forms the air floating video 3 that is an actual image outside the transparent member 100. The polarization splitter 101 may be made of, for example, a reflection-type polarizer plate or a metal multilayer film that reflects the specific polarization wave.

In the configuration of FIG. 2, when the user visually recognizes the air floating video 3 in a direction of an arrow A, the air floating video 3 is visually recognized as a bright video. However, when a different person visually recognizes the air floating video 3 in a direction of an arrow B, the air floating video 3 cannot be visually recognized as a video at all. Such a property is very suitable for application to a system displaying a video requiring high security, a video having high confidentiality that needs to be secured for a person facing the user or the like.

In the present embodiment, a configuration in which the video display surface of the video display 1 is provided with an absorption-type light polarizer 12 has been explained. In the absorption-type light polarizer 12, the re-reflection can be suppressed since the video light emitted from the video display 1 is transmitted through the absorption-type light polarizer 12 while the reflection light returning from the polarization splitter 101 is absorbed by the absorption-type light polarizer 12. Therefore, according to the present embodiment using the absorption-type light polarizer 12, the reduction in the image quality due to the ghost image of the air floating video 3 can be prevented or suppressed by the air floating video apparatus using the reflection-type retroreflector.

As a result of the studies, the present inventors have found the invention of the present application by studying a retroreflection optical system achieving a portable air floating video display apparatus improving a quality of an air floating video formed by an air floating video display system using a transmission-type retroreflector or a reflection-type retroreflector and having low power consumption enabled to be driven by a battery in compatible with a small video display 1.

The invention of the present application will be explained in detail below with reference to the drawings.

### Layout Achieving Small Apparatus

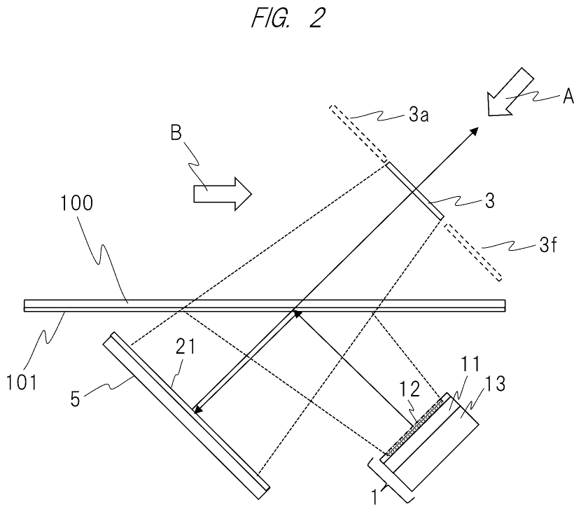

FIG. 3 illustrates a structure with a liquid crystal panel 11, a FPC (Flexible printed circuits) 249 and a circuit board 251. The liquid crystal panel 11 and the circuit board 251 are connected by the FPC 249. The light emitted from LED chips that are surface light sources on a line in a direction parallel to a short side of the liquid crystal panel 11 as illustrated in

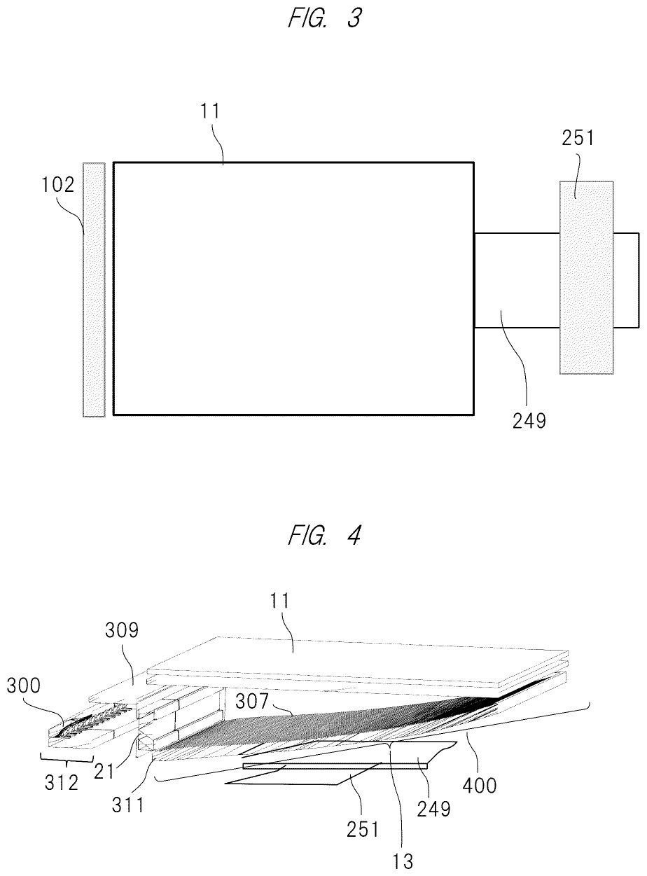

FIG. 4 is converted into substantially collimated light by a reflector 300, is converted in terms of polarization by a PBS (Polarizing Beam Splitter) 21, enters a reflection-type light guiding body 311, as the specific polarization light, and then, is reflected on a reflection surface 307, and enters a desirable position of the liquid crystal panel 11, at a desirable angle. The reflection-type light guiding body 311 has a gradient with respect to a light source block 312 illustrated in FIG. 4, and the circuit board 251 is arranged below the reflection-type light guiding body 311 by bending the FPC 249 of the liquid crystal panel 11. The thinner structure can be achieved when the circuit board 251 is arranged along a back surface of the reflection-type light guiding body 311. Since an wasted space can be reduced by this structure, the light source 13 and the liquid crystal panel 11 can be housed in the housing to achieve a compact structure.

The layout in which the light source block 312 is arranged in the short-side direction of the liquid crystal panel 11 has been explained with reference to FIG. 4. However, a layout in which the light source block is arranged in a long-side direction of the liquid crystal panel 11 is also similar. Alternatively, even when the light source blocks 312 are arranged to face each other on the long side and short side of the liquid crystal panel 11, the liquid crystal panel 11, the FPC 249 and the circuit board 251 may be similarly arranged as described above. Since an wasted space can be reduced by this structure, the light source 13 and the liquid crystal panel 11 can be housed in the housing to achieve a compact structure.

### First Example of Small Air Floating Video Display Apparatus

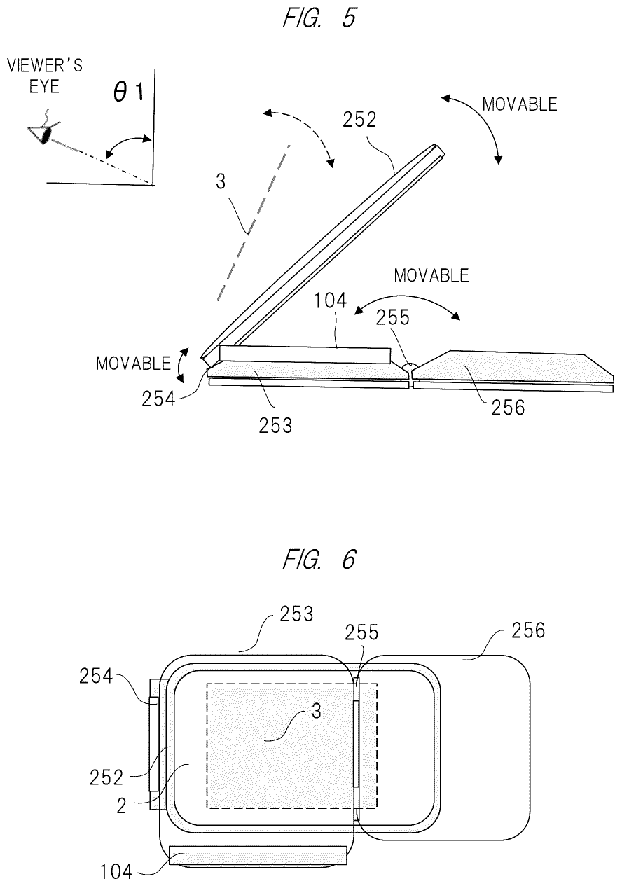

FIG. 5 illustrates a structure in which a compact housing 253 including the liquid crystal panel 11 and the light source 13 therein is movably joined or connected with a power supply 256 by a hinge 255. The power supply 256 is, for example, a battery pack of wireless charging type or the like. The transmission-type retroreflector 2 is held by a flame structure 252. The flame structure 252 is movably connected with one side of the housing 253 through a second joint with respect to the housing 253, and the power supply 256 is movably connected with the other side of the housing 253 through a first joint. In other words, the flame structure 252 is movably connected with one side of the housing 253 through a hinge 254 with respect to the housing 253, and the power supply 256 is movably connected with the other side of the housing 253 through a hinge 255. An end of the housing 253, the end being on the side connected with the flame structure 252, is opposite to an end of the housing 253, the end being on the side connected with the power supply 256. And, the flame structure 252 is not connected with the opposite other side of the power supply 256 to the end of the power supply 256, the end being on the side joined with the housing 253 through the hinge 255. However, the other side can be brought in contact with one end of the flame structure 252 if being movable toward the flame structure 252 through the hinge 255. As a result, the transmission-type retroreflector 2 can be fixed to an optional angle from the housing 253 including the liquid crystal panel 11 and the light source 13 therein, and therefore, the transmission-type retroreflector 2 is optionally movable.

In the display of the air floating video 3, the opposite other side of the flame structure 252 to the end itself joined with the hinge 254 is rotatable around the hinge 254 toward the light emission side of the liquid crystal panel 11 included in the housing 253. And, the opposite other side of the power supply 256 to the end itself joined with the hinge 255 is rotatable around the hinge 255 toward the air floating video 3. As a result, the optimum position and direction as the image formation position of the air floating video 3 can be adjusted toward the viewer's viewpoint, in other words, toward an angle θ1 from a perpendicular line in FIG. 5. Note that the hinge 255 may be referred to as first connecting portion, and the hinge 254 may be referred to as second connecting portion. Each of the first and second joints may include a joint member and a movable member.

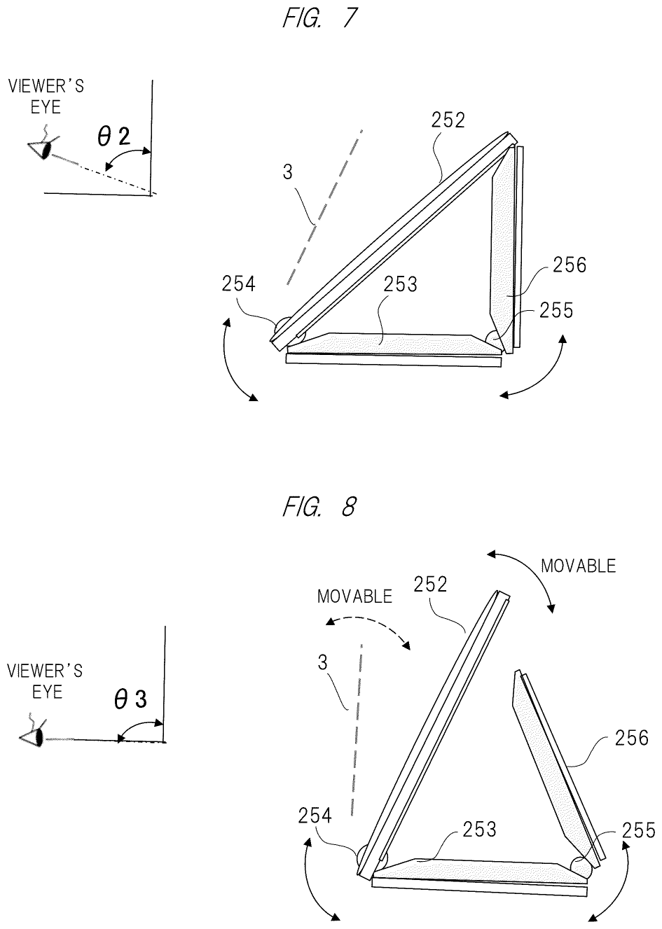

FIG. 6 is a top view illustrating a configuration of an air floating video display system according to one embodiment of the present invention illustrated in FIG. 5. An upper end image of the air floating video 3 is not formed to be upper than a line segment connecting the viewer's viewpoint and an upper end of the transmission-type retroreflector 2. Therefore, in order to enhance the floating texture, a mark may be added such that the viewpoint tends to move toward an end of the flame structure 252, the end heading to the viewer, particularly toward its upper portion that is its end being on the side not connected or joined with the housing 253 through the hinge 254. And, if the upper portion of the air floating video 3 has a black display portion, the floating texture can be further enhanced. In FIGS. 5 and 6, in order to release the heat generated in the LED to outside, a metallic fin 104 may be exposed to outside of the housing, or may be arranged inside the housing.

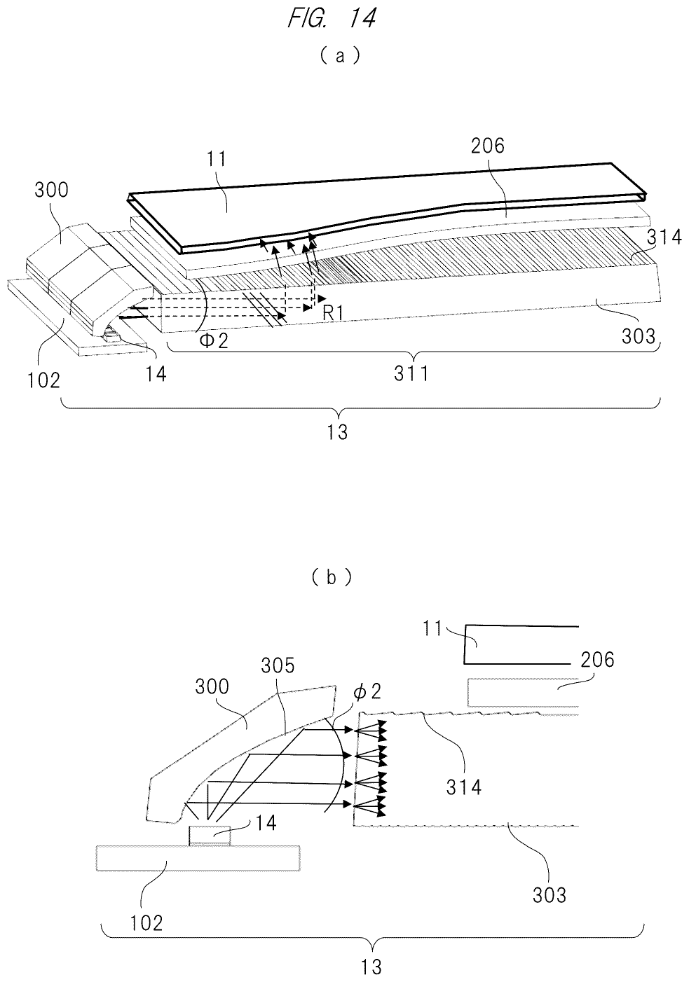

As illustrated, the air floating video display apparatus illustrated in FIG. 13A includes the housing substantially having a tubular shape, particularly a cylindrical shape. The air floating video display apparatus including the cylindrical housing is of a storable bottle holder (also referred to as drink holder) type, and is a relatively small (compact) and portable air floating video display apparatus. For example, such an air floating video display apparatus can be appropriately placed on a bottle holder (also referred to as drink holder), a dashboard or the like in a vehicle. This cylindrical shape is a shape having a cylinder axis extending in a height direction (corresponding to a vertical direction) and having a cylinder diameter extending in a direction (corresponding to a horizontal direction) perpendicular to the height direction. The cylindrical housing roughly has an upper housing and a lower housing that are connected to each other. Note that the upper housing and the lower housing are integrally or not integrally connected to each other. An optical system and a control circuit board, or a battery if needed or the like are housed inside the housing.

FIG. 13A illustrates a configuration of the drink-holder type air floating video display system using the transmission-type retroreflector 2. FIG. 13A(1) illustrates a perspective view of the drink-holder type air floating video display system using the transmission-type retroreflector 2, FIG. 13A(2) illustrates a front view of the drink-holder type air floating video display system using the transmission-type retroreflector 2, and FIG. 13A(3) illustrates a side view of the drink-holder type air floating video display system using the transmission-type retroreflector 2. The air floating video display apparatus of the present example includes the housing 253 including the power supply 256, the flame structure 252 and the video display. For balancing in such a drink-holder type air floating video display apparatus, the retroreflector 2 and the video display are arranged in the upper housing while the power supply 256 is arranged in the lower housing. The housing 253 includes the liquid crystal panel 11 and the light source 13 therein. The flame structure 252 holds the transmission-type retroreflector 5. The video display includes the light source and the liquid crystal display panel.

As illustrated in FIG. 13A, the housing 253 tilts from the power supply 256, and one end of the housing 253 is fixed to a supporting portion 258 while the opposite other end of the housing 253 is movably joined with the flame structure 252 through a hinge 260. Note that it is assumed that the end of the housing 253, the end being on the side joined with the supporting portion 258 in the present embodiment, is a lower portion that is a region close to the power supply 256 while the end of the housing 253, the end being on the side joined with the flame structure 252, is an upper portion. The supporting portion 258 has a concave portion therein in the vertical or height direction, and the housing 253 is fixed to the concave portion. As illustrated in FIG. 13A(3), the supporting portion 258 has a U shape. This shape is not limited to this, and a different shape is also applicable depending on design. The end of the housing 253 movably joined with the flame structure 252 through the hinge is the same in height as the upper portion of the supporting portion 258. That is, the opposite end to the end of the housing 253, the end being fixed to the concave portion, is the same in height as the upper portion of the supporting portion 258. In FIG. 13A(1), the video light emitted from the video display included in the housing 253 is transmitted through the transmission-type retroreflector 2, and aerially forms the air floating video (not illustrated) to be opposite to the supporting portion 258 with respect to the flame structure 252. The opposite end of the flame structure 252 to its end joined with the hinge 260 is in contact with the supporting portion 258, and is rotatable around the hinge 260 toward the air floating video to fit with the line of sight of the user. Note that the supporting portion 258 may be referred to as first joint or first connecting portion, and the hinge 260 may be referred to as second joint or second connecting portion.

Meanwhile, as another arrangement example of the drink-holder type air floating video apparatus other than the arrangement of FIG. 13A, the video display included in the housing 253 may be arranged in the height direction of the supporting portion 258. In this case, since the end of the flame structure 252 is movably fixed to the upper portion of the supporting portion 258 through the hinge 260, the movable region of the retroreflector 2 held by the flame structure 252 is expanded, and the display position of the air floating video can be adjusted to fit with the line of sight of the user. Also, the visual recognition of the air floating video is improved by arrangement of sidewalls on side surfaces other than a side surface of the housing 253 connected to the hinge 260 and a side surface of the housing 253 connected to the supporting portion 258 for preventing external light. The sidewalls may be arranged on both sides of a space surrounded by the housing 253, the supporting portion 258 and the flame structure 252. The sidewalls may be detachable, foldable or storable. For example, the sidewalls may be arranged on both ends without hinges in the housing 253.

By the configuration, the air floating video display system achieving the small portable design and the lower power consumption is provided. In the air floating video display system, the display panel displaying the video and the light source for the display panel are included in the same housing, and a mobile battery is connected to, by a flange, a protecting member that protects the transmission-type retroreflector reflecting the video light of the display panel and causing the reflected light to aerially display the air floating video of the real image. In this manner, the system form is changed depending on the use form, thereby providing the portability, and the power consumption can be significantly reduced since the directionality of the light source has the narrow angular property.

### Layout Method of Fixing Air Floating Video

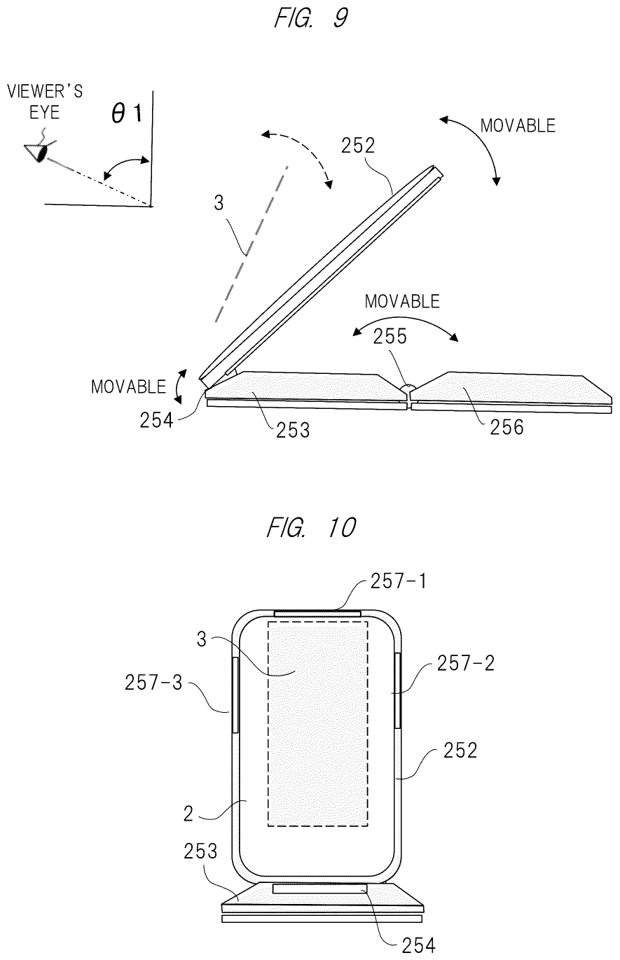

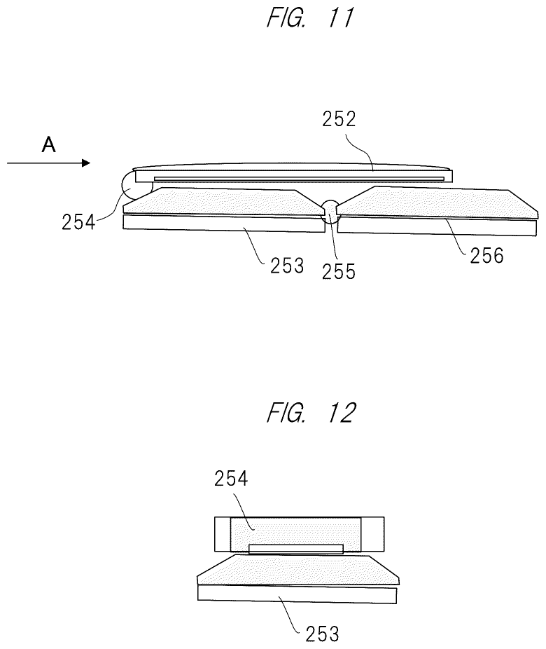

FIG. 7 is a second side view illustrating a configuration in which the air floating video 3 is fixed to fit to the line of sight of the viewer, that is, fit to an angle θ2 with respect to the perpendicular line in FIG. 7 in the air floating video display system according to the embodiment of the present invention. The housing 253 and the power supply 256 are connected to each other when rotating around the hinge 255. The upper end of the flame structure 252, that is, the end thereof not connected or joined with the housing 253 by the hinge 254, is made in contact with the end of the power supply 256 not connected with the housing 253 by the hinge 255, and an angle between the housing 253 and the transmission-type retroreflector 2 held by the flame structure 252 is fixed. Note that the power supply 256 is, for example, a battery pack of a wireless charging type or the like. Since the hinges are arranged on both ends of the housing 253 including the liquid crystal panel 11 and the light source 13 therein, the air floating video display system can be upgraded depending on the use form. Also, the visual recognition of the air floating video is improved by arrangement of sidewalls on side surfaces other than the side surface of the housing 253 connected to the hinge 260 and the side surface of the housing 253 connected to the supporting portion 258 for preventing external light. The sidewalls may be detachable, foldable or storable. For example, the sidewalls may be arranged on both ends without hinges in the housing 253. And, when the flame structure 252 holding the transmission-type retroreflector 2 is vertically brought close to the housing 253 as illustrated in FIG. 7, the angle of the air floating video 3 can be also vertically adjusted with respect to the base surface, and the position of the air floating video 3 can be adjusted to fit to the line of sight of the viewer, that is, fit to an angle θ3 with respect to the perpendicular line in FIG. 8. And, as similar to FIG. 7, even the layout of FIG. 8 can also block the external light entering the back side (right side in the drawing) of the transmission-type retroreflector 2, in other words, entering the light incident surface of the retroreflector 2, and therefore, the image quality, particularly the contrast performance of the air floating video 3 is significantly improved.

### Second Example of Small Air Floating Video Display Apparatus

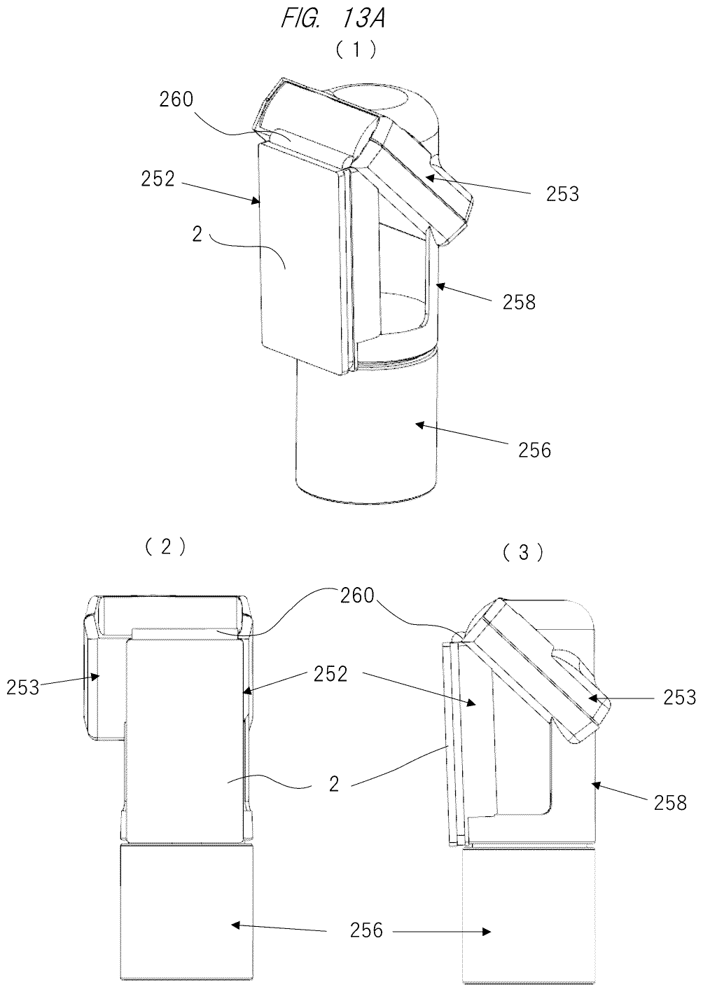

FIG. 9 illustrates a side view illustrating a second example of the air floating video display apparatus. As similar to the first example, this illustrates the configuration in which the compact housing 253 including the liquid crystal panel 11 and the light source 13 therein is movably joined or connected with the power supply 256 by the hinge 255. The power supply 256 is, for example, a battery pack of wireless charging type or the like. The transmission-type retroreflector 2 is held by the flame structure 252, and is connected with the end of the housing 253 by the hinge 254, the end being on the side not connected with the power supply 256 by the hinge 255. As a result, the transmission-type retroreflector 2 can be fixed at an optional angle with respect to the housing 253 including the liquid crystal panel 11 and the light source 13 therein, and the transmission-type retroreflector 2 is movable. As a result, the optimum position and direction as the image formation position of the air floating video 3 can be adjusted toward the viewer's viewpoint, in other words, toward an angle θ1 from a perpendicular line in FIG. 9. Note that the hinge 255 may be referred to as first joint, the hinge 254 may be referred to as second joint, and the hinge may be referred to as connecting portion. Also, the visual recognition of the air floating video is improved by arrangement of sidewalls on both sides of a triangular prism space surrounded by the housing 253, the power supply 256 and the flame structure 252 for preventing the external light. The sidewalls may be detachable, foldable or storable.

### Enlargement Effect of Air Floating Amount by Perceptual Illusion

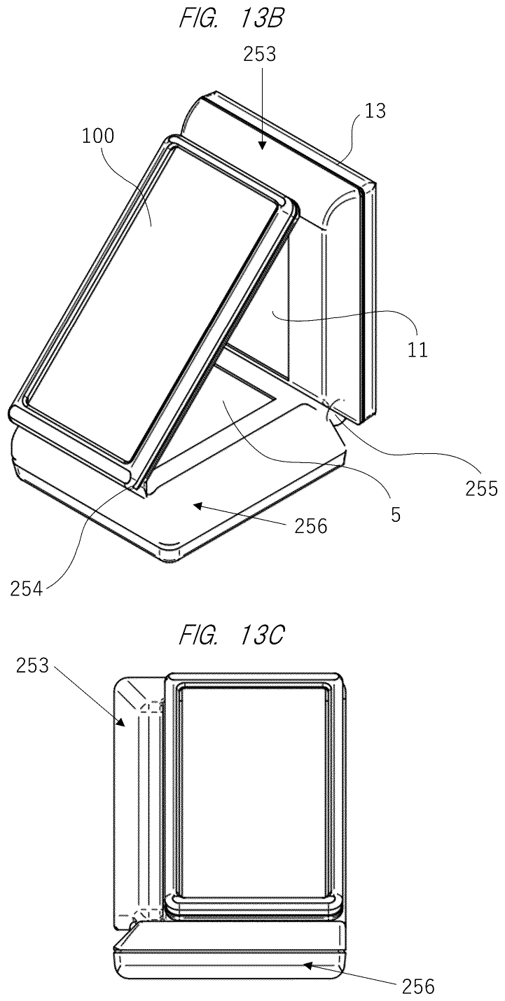

FIG. 10 is a front view illustrating a configuration of the air floating video display system according to one embodiment of the present invention illustrated in FIG. 9. In the upper end of the air floating video 3, in other words, in a side where the housing 253 is not arranged, the image is not formed to be upper than the line segment connecting the viewer's viewpoint and the upper end of the transmission-type retroreflector 2, in other words, the side where the housing 253 is not arranged. Therefore, the present inventors have studied the specific technical means of making the viewer largely recognize the floating texture of the air floating video. As a result, a mark 257-1 is added to the end of the flame structure 252, the end being not on the side connected with the housing 253 by the hinge 254, such that the viewpoint tends to move toward the end of the flame structure 252, the end heading to the viewer, particularly toward its upper portion that is its end being on the side not connected or joined with the housing 253 through the hinge 254. The viewer's attention is further headed toward marks by adding the similar marks 257-2 and 257-3 to side surfaces of the flame structure 252, in other words, its side surfaces not opposite to the retroreflector 2 as different from the surface for the mark 257-1. The present inventors have found out that this result provides the effect of making the viewer recognize the larger floating amount of the air floating video 3 than the original amount. In FIGS. 9 and 10, as different from the first example, the metallic fin 104 (not illustrated) for releasing the heat generated in the LED to outside is not exposed to outside but arranged inside the housing. Note that the metallic fin 104 may be arranged outside the housing.

### Non-Display State of Air Floating Video Display Apparatus

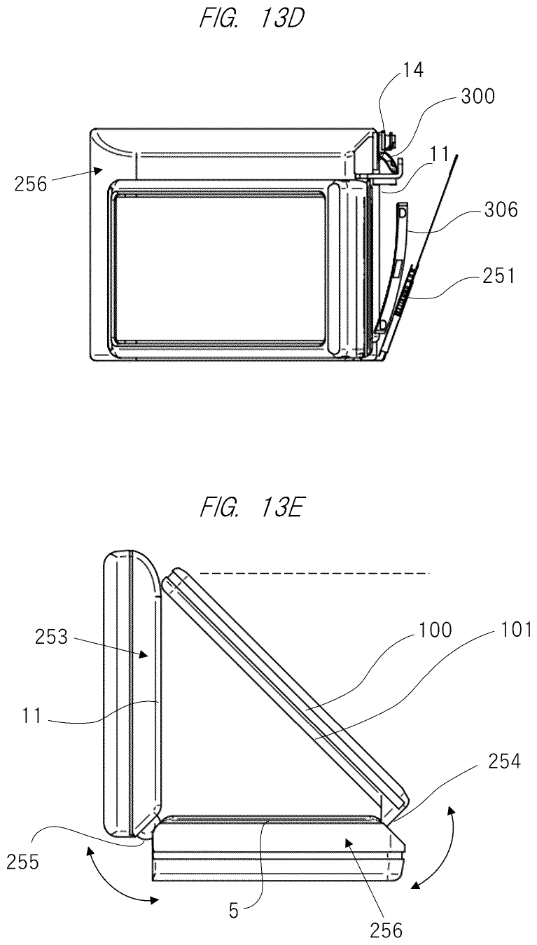

FIG. 11 is a side view illustrating a state in which the air floating video 3 is not displayed in the air floating video display apparatus. The power supply 256 and the compact housing 253 including the liquid crystal panel 11 and the light source 13 therein are joined or connected with each other by the hinge 255, and are arranged side by side in the lateral direction. That is, although the power supply 256 and the housing 253 are movable because of the hinge 255, an angle between the power supply 256 and the housing 253 in FIG. 11 is about 180 degrees. The flame structure 252 holding the transmission-type retroreflector 2 in the upper side of the power supply 256 and the housing 253 is connected with the housing 253 by the hinge 254 provided on the end of the housing 253, the end being on the side not connected with the power supply 256 by the hinge 255, and therefore, is foldable because of the hinge 254. As a result, the transmission-type retroreflector 2 is fixed and held while overlapping the power supply 256 and the housing 253 including the liquid crystal panel 11 and the light source 13 therein, and therefore, the thinnest structure is achieved, and the portable thickness is achieved. Also, in the state in which the air floating video 3 is not displayed, the opposite other side of the flame structure 252 to the end joined with the hinge 254 may be rotated toward the light emission side of the liquid crystal panel 11 included in the housing 253 and be folded, or may be rotated toward the opposite side to the light emission side of the liquid crystal panel 11 and be folded. If the opposite other side of the flame structure 252 to the end joined with the hinge 254 is rotated toward the light emission side of the liquid crystal panel 11 and is folded, adhesion of dusts or the like to the liquid crystal panel 11 can be prevented. On the other hand, if the opposite other side of the flame structure 252 to the end joined with the hinge 254 is rotated toward the opposite side to the light emission side of the liquid crystal panel 11 and is folded, the apparatus is shortened but thickened in the long-side direction. Therefore, the folding form can be adjusted depending on the user's needs. Note that the power supply 256 is, for example, a battery pack of wireless charging type or the like.

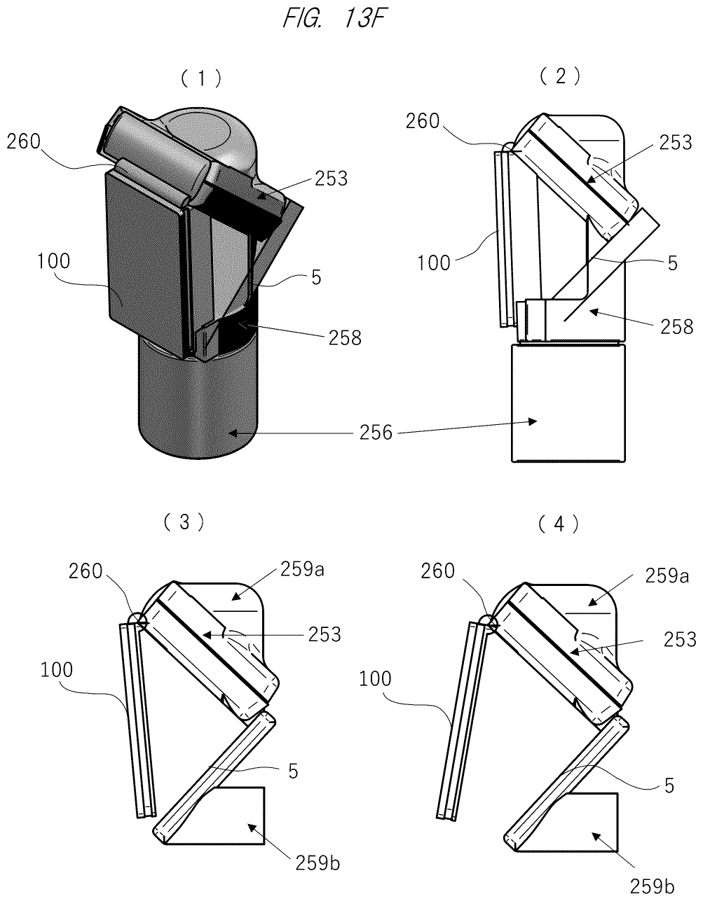

FIG. 12 is a perspective view A provided by viewing the air floating video display system according to one embodiment of the present invention illustrated in FIG. 11 from a side “A”. When lateral widths, in other words, thicknesses in the vertical direction and thicknesses in the vertical direction of the power supply 256 and the housing 253 are made equal to each other, the integral configuration is achieved, and therefore, the air floating video display system having the excellent portability can be achieved.

In the air floating video display apparatus of the present example, even if the viewer peeks at the air floating video 3, the light from the video display surface of the liquid crystal panel 11 is shielded by the reflection surface of the retroreflector 2. Therefore, in the air floating video display apparatus, since the liquid crystal panel and the retroreflector are arranged to have the angle therebetween, it is difficult to directly view the displayed image on the liquid crystal display panel.

Further, the reflectance of the video light from the liquid crystal display panel 11 can be increased in principle by a reflector member such as the retroreflector, and therefore, a S-polarization wave may be used. However, if the viewer uses polarization sunglasses, the air floating video is reflected or absorbed by the polarization sunglasses. Therefore, in order to take measures against this, the surface of the transmission-type retroreflector 2 close to the viewer, that is, the surface thereof close to the air floating video 3 may be provided with a depolarizing element 103 that optically converts a part of the video light of the specific polarization wave into the other polarization wave to be virtually converted into natural light. As a result, even if the viewer uses the polarization sunglasses, the viewer can view the favorable air floating video. When this is optically coupled with a transparent plate 100 by an adhesive, the light reflection surface is not formed, and therefore, the image quality of the air floating video is not reduced.

As commercially available products of the depolarizing element, COSMOSHINE SRF (manufactured by Toyobo Co., Ltd) and a depolarizing adhesive (manufactured by Nagase (sangyo) & Co., Ltd) are exemplified. In the case of COSMOSHINE SRF (manufactured by Toyobo Co., Ltd), when the adhesive is adhered on the video display, the reflection on the interface can be reduced to improve the luminance. In addition, in the case of the depolarizing adhesive, the depolarizing adhesive is used so that a colorless transparent plate and the video display are adhered to each other through the depolarizing adhesive. In the present example, as described above, the video display 1 includes the liquid crystal display panel 11 and the light source 13 generating the light of the polarized wave having the narrow-angle diffuse property.

### Third Example of Small Air Floating Video Display Apparatus

Each of FIGS. 13B, 13C, 13D and 13E illustrates a configuration of the air floating video display system using the reflection-type retroreflector 5. FIG. 13B is a perspective view of the air floating video display system using the reflection-type retroreflector 5. FIG. 13C is a front view of the air floating video display system using the reflection-type retroreflector 5. FIG. 13D is a top view of the air floating video display system using the reflection-type retroreflector 5. FIG. 13E is a side view of the air floating video display system using the reflection-type retroreflector 5. FIG. 13D illustrates a view such that contents of the housing 253 are observable, and illustrates a part of the light source 13. The light source 13 includes an LED 14, a reflector 300 and a light guiding body 306. The detailed explanation for the light source 13 will be described later, and therefore, will not be described here.

Each of FIGS. 13B to 13E illustrates an embodiment corresponding to one example of the present invention. The housing 253 includes the liquid crystal panel 11 and the light source 13 therein, and the housing 253 is movably joined or connected with the power supply 256 by the hinge 255. The reflection-type retroreflector 5 is arranged between the first joint and the second joint. The reflection-type retroreflector 5 is arranged on an upper side of the power supply 256, the upper side being on a side where the air floating video is formed. The reflection-type retroreflector 5 may be adhered on the power supply 256, or may be arranged on the upper side of the power supply 256 while being fixed by a flame structure or the like. The power supply 256 is, for example, a battery pack of wireless charging type or the like. The power supply 256 is connected with the transparent member 100 by the hinge 254. For example, as illustrated in FIG. 13B, an angle between the power supply 256 and the housing 253 is adjusted to be about 90 degrees by the hinge 255, and the transparent member 100 is adjusted to be in contact with the end of the housing 253 by the hinge 254, the end being on the side not attached with the hinge 255. In this case, the light emitted from the light source 13 enters the liquid crystal display panel 11, the light emitted from the liquid crystal display panel 11 is reflected on the polarization light splitter 101 (not illustrated) provided on the light entering surface of the transparent member 100, the reflected light is reflected on the reflection-type retroreflector 5, and then, is transmitted through the transparent member 100, and aerially forms the air floating video (not illustrated).

With respect to the power supply 256, the transparent member 100 is movably connected with one side of the power supply 256 through the second joint, and the housing 253 is movably connected with the other side of the power supply 256 through the first joint. That is, with respect to the power supply 256, the transparent member 100 is movably connected with one side of the power supply 256 through the hinge 254, and the housing 253 30 is movably connected with the other side of the power supply 256 through the hinge 255. The end of the power supply 256, the end being connected with the transparent member 100, is opposite to the end of the power supply 256, the end being connected with the housing 253. The transparent member 100 is not connected with the opposite other end of the housing 253 to the end of the housing 253, the end being on the side joined with the power supply 256 through the hinge 255. However, the other side can be brought in contact with one end of the transparent member 100 when the housing 253 is movable toward the transparent member 100 through the hinge 255. As a result, the transparent member 100 can be fixed at an optional angle with respect to the power supply 256, and therefore, the transparent member 100 is optionally movable. In a case in which the air floating video 3 is displayed, the opposite other side of the transparent member 100 to its end joined with the hinge 254 is rotatable around the hinge 254 toward the light emission side of the retroreflector 5. Also, the opposite other side of the housing 253 to its end joined with the hinge 255 is rotatable around the hinge 255 toward the air floating video side. As a result, the optimum position and direction as the image formation position of the air floating video can be adjusted toward the viewer's viewpoint. Note that the hinge 255 may be referred to as first connecting portion, and the hinge 254 may be referred to as second connecting portion. Also, each of the first and second joints may include a joint member and a movable member.

The visual recognition of the air floating video is improved by arrangement of sidewalls on both sides of triangular prism space surrounded by the housing 253, the power supply 256 and the transparent member 100 for preventing the external light. The sidewalls may be detachable, foldable or storable. For example, the sidewall may be appropriately arranged on an end of the power supply 256 or the housing 253, the end being on the side without the hinge.

Each of FIGS. 13D and 13E illustrates an embodiment corresponding to another example of the present invention illustrated in FIG. 2. The housing 253 including the liquid crystal panel 11 and the light source 13 therein is movably joined or connected with the power supply 256 by the hinge 255. The reflection-type retroreflector 5 is joined with the transparent member 100 by the hinge 254, and is held at a predetermined position by a holding force of the hinge 254. FIG. 13D is a top view of the example illustrated in FIG. 13E, but illustrates an example in which the position of the housing 253 is opposite to that of FIG. 13E. Also, the light source of the housing 253 is transparently illustrated to show the layout of the liquid crystal panel 11, a reflection-type light guiding body 306 and a driver circuit 251.

In FIGS. 13zb to 13E, a mark may be added to the end of the transparent member 100, the end being not connected with the power supply 256 by the hinge 254, such that the viewpoint tends to move toward the end of the transparent member 100, the end heading to the viewer, particularly toward its upper portion that is its end being not on the side joined or connected with the power supply 256 by the hinge 254. The viewer's attention is further headed toward marks by adding the similar marks to side surfaces of the transparent member 100, in other words, its side surfaces not opposite to the retroreflector 5 as different from the surface for the mark. The present inventors have found out that this result provides the effect of making the viewer recognize the larger floating amount of the air floating video than the original amount. The metallic fin (not illustrated) for releasing the heat generated in the LED to outside is not exposed to outside but arranged inside the housing. Note that the metallic fin may be arranged outside the housing.

In the state in which the air floating video is not displayed, the angle between the housing 253 and the power supply 256 is set to about 180 degrees, and the transparent member 100 can be folded by the hinge 254 toward the light emission side of the liquid crystal panel 11 included in the housing 253. As a result, the thinnest structure is achieved, and the portable Also, in the state in which the air thickness is achieved. floating video is not displayed, the transparent member 100 and the housing 253 that houses the video display can be freely folded by the hinges 254 and 255 toward the opposite side. Meanwhile, if the opposite other side of the transparent member 100 to its end joined with the hinge 254 is rotated toward the opposite side to the light emission side of the liquid crystal panel 11 and is folded, the apparatus is shortened but thickened in the long-side direction. Therefore, the folding form can be adjusted depending on the user's needs.

As illustrated, the air floating video display apparatus illustrated in FIG. 13F includes the housing substantially having a tubular shape, particularly a cylindrical shape. The air floating video display apparatus the cylindrical housing is of a storable bottle holder (also referred to as drink holder) type, and is a relatively small (compact) and portable air floating video display apparatus. For example, such an air floating video display apparatus can be appropriately placed on a bottle holder (also referred to as drink holder), a dashboard or the like in a vehicle. This cylindrical shape is a shape having a cylinder axis extending in a height direction (corresponding to a vertical direction) and having a cylinder diameter extending in a direction (corresponding to a horizontal direction) perpendicular to the height direction. The cylindrical housing roughly has an upper housing and a lower housing that are connected to each other. Note that the upper housing and the lower housing are integrally or not integrally connected to each other. An optical system and a control circuit board, or a battery if needed or the like are housed inside the housing.

FIG. 13F illustrates a configuration of the air floating video display system using the reflection-type retroreflector 5 illustrated in example of the present invention illustrated in FIG. 2. FIG. 13F(1) illustrates a perspective view of the drink-holder type air floating video display system using the reflection-type retroreflector 5, FIG. 13F(2) illustrates a side view of the drink-holder type air floating video display system using the reflection-type retroreflector 5, and each of FIGS. 13F(3) and 13F(4) illustrates a side view of another example of the drink-holder type air floating video display system using the reflection-type retroreflector 5. In FIGS. 13F(3) and 13F(4), the power supply is omitted. The air floating video display apparatus of the present example includes the housing 253 including the power supply 256, the reflection-type retroreflector 5 and the video display. For balancing in such a drink-holder type air floating video display apparatus, the reflection-type retroreflector 5 and the video display are arranged in the upper housing while the power supply 256 is arranged in the lower housing. The housing 253 includes the liquid crystal panel 11 and the light source 13 therein. The air floating video display apparatus also includes the transparent member 100.

As illustrated in FIG. 13F, the retroreflector 5 is arranged in the supporting portion 258 while tilting from the power supply 256. The housing 253 tilts from the power supply 256, and one end of the housing 253 is joined with the supporting portion 258 while the other end of the housing 253 is movably joined with the transparent member 100 through the hinge 260. Note that it is assumed that the end of the housing 253, the end being on the side joined with the supporting portion 258 in the present embodiment, is a lower portion that is a region close to the power supply 256 while the end of the housing 253, the end being on the side joined with the transparent member 100 through the hinge 260, is an upper portion. The supporting portion 258 has a concave portion formed in the vertical or height direction, and one end of the housing 253 and one end of the retroreflector 5 are fixed to the concave portion. As illustrated in FIG. 13F(2), the supporting portion 258 has a U shape. This shape is not limited to this, and a different shape is also applicable depending on design. For example, as illustrated in FIGS. 13F(3) and 13F(4), the shape of the supporting portion is not the U shape, but is made of separate bodies such as a supporting portion 259a of the housing 253 and a supporting portion 259b of the retroreflector 5. A connecting portion between the housing 253 and the retroreflector 5 may be tightly connected with the side surface of the housing 253, or may be partially connected therewith. In FIGS. 13F(1) to 13F(4), the angle between the housing 253 and the retroreflector 5 is set to about 90 degrees. The display position of the air floating video can be adjusted by the position of the transparent member 100 that is rotatable around the hinge 260 toward the air floating video side (not illustrated). Depending on the user's needs, FIG. 13F(3) may be the non-display state while FIG. 13F(4) may be the display state.

The end of the housing 253, the end being movably joined with the transparent member 100 through the hinge 260, is the same in height as the upper portion of the supporting portion 258. That is, the opposite end to the end of the housing 253, the end being fixed to the concave portion, is the same in height as the upper portion of the supporting portion 258. The concave portion may penetrate through. In this case, the end of the housing 253 and the end of the retroreflector 5 penetrate through the hole of the supporting portion 258, and protrude therefrom. In FIG. 13F(1), the video light emitted from the video display included in the housing 253 is reflected on the polarization light splitter (not illustrated) provided on the light entering surface of the transparent member 100, the reflected light is reflected on the reflection-type retroreflector 5, and then, is transmitted through the transparent member 100, and aerially forms the air floating video (not illustrated) on the opposite side to the supporting portion 28 with respect to the transparent member 100. Note that the supporting portion 258 may be referred to as first joint or first connecting portion, and the hinge 260 may be referred to as second joint or second connecting portion. The visual recognition of the air floating video is improved by arrangement of sidewalls on both sides of a triangular prism space surrounded by the housing 253, the power supply 256 and the transparent member 100 for preventing the external light. The sidewalls may be detachable, foldable or storable. For example, the sidewall may be appropriately arranged on an end of the power supply 256 or the housing 253, the end being on the side without the hinge.

By the configuration, the air floating video display system achieving the small portable design and the lower power consumption is provided. In the air floating video display system, the display panel displaying the video and the light source for the display panel are included in the same housing, and a mobile battery is connected to, by a flange, a protecting that protects the reflection-type retroreflector member reflecting the video light of the display panel and causing the reflected light to aerially display the air floating video of the real image. In this manner, the system form is changed depending on the use form, thereby providing the portability, and the power consumption can be significantly reduced since the directionality of the light source has the narrow angular property.

### Video Light Control Sheet

In order to make difference in the diffuse property between the screen vertical direction and the screen horizontal direction in the video display 1, a video light control sheet is provided on the video light emission surface of the liquid crystal panel 11. For the video light control sheet, for example, a viewing-angle control film (VCF) manufactured by Shin-Etsu Polymer Co., Ltd., is suitable, and a structure of the VCF has a sandwich structure in which transparent silicon and black silicon are alternately arranged while the light entering/emitting surface is provided with a synthetic resin. Therefore, the same effect as that of the external-light control film in the present embodiment can be expected. The viewing-angle control film (VCF) in this case has the structure in which the transparent silicon and the black silicon extending in a predetermined direction are alternately arranged, and therefore, the extending direction of the transparent silicon and the black silicon in the video light control sheet is tilted from the vertical direction of the array direction of pixels of the liquid crystal panel 11 to reduce the moire formed at the pitches of the pixels and the external light control film.

(1) Vertical stripes generated by the light transmitting portions and the light absorbing portions of the video light control sheet are arranged to tilt from the arrangement of pixels of the liquid crystal panel 11 in order to reduce the moire formed by the vertical stripes and the arrangement of pixels. Further, (2) in an assumption that the pixel dimension of the liquid crystal panel 11 is “A” while the pitch between the vertical stripes of the video light control sheet 12 is “B”, a ratio (B/A) thereof is selected to a value deviating from an integral multiple, thereby causing the effect of reducing the moire.

One pixel of the liquid crystal panel is made of three parallel pixels of three colors RGB, and is typically square, and thus, the formation of the moire cannot be suppressed in the entire screen. Thus, it has been experimentally found that the tilt described in the method (1) may be optimized in a range of 5 degrees to 25 degrees in order to intentionally shift the formation position of the moire to a position at which the air floating video is not displayed. The liquid crystal panel has been described as the subject to be described for reducing the moire. However, the moire is formed between the retroreflector 2 and the video light control sheet 250 since the retroreflector and the video light control sheet are linear structures, and therefore, the video light control sheet is optimally tilted with respect to the arrangement of the pixels of the liquid crystal panel to reduce the large viewable moire with low frequency.

As illustrated in FIG. 3, the video light control sheet 250 is arranged on the video light emission surface of the liquid crystal panel 11, and is bonded and fixed to the video light emission surface of the liquid crystal panel 11 by a bonding member.

### Performance of Liquid Crystal Panel

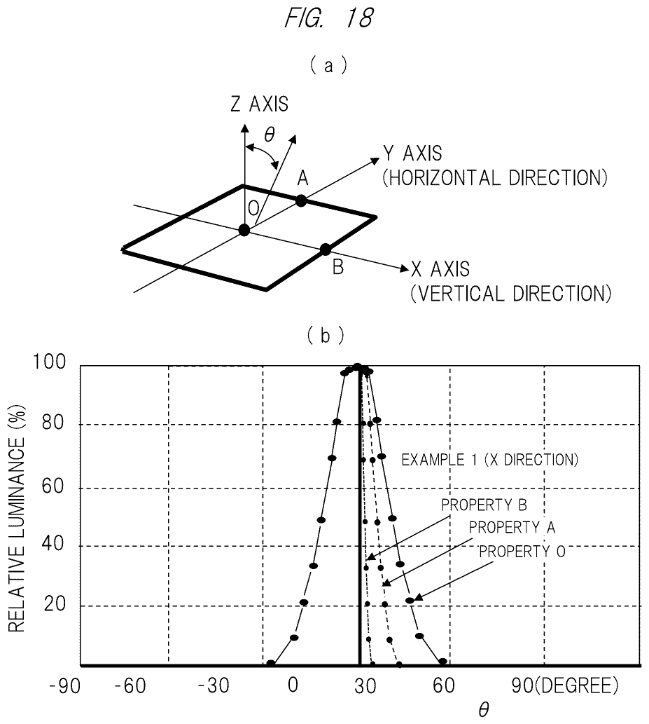

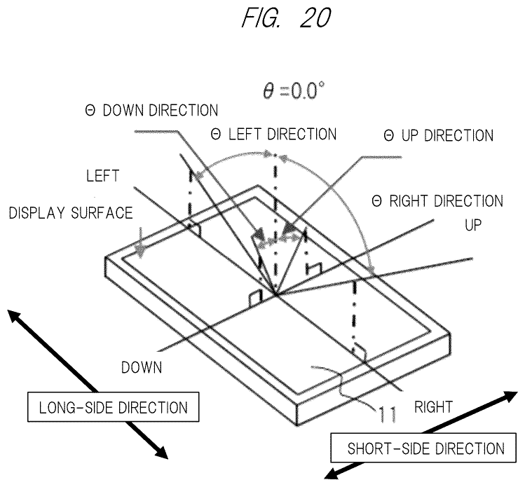

Incidentally, a general thin film transistor (TFT) liquid crystal panel has the luminance and the contrast performance depending on the light emission direction because of the properties of both liquid crystals and a polarizer. In the evaluation under measurement environment illustrated in FIG. 20, the properties of the luminance and the viewing angle in the panel short-side (vertical) direction are excellent at an angle shifting slightly (by +5 degrees in this embodiment) from the emission angle orthogonal to the panel surface (the emission angle of 0 degree) as illustrated in FIG. 22. This is because the light twist property in the short-side (vertical) direction of the liquid crystal panel is not 0 degree at the maximum applied voltage.

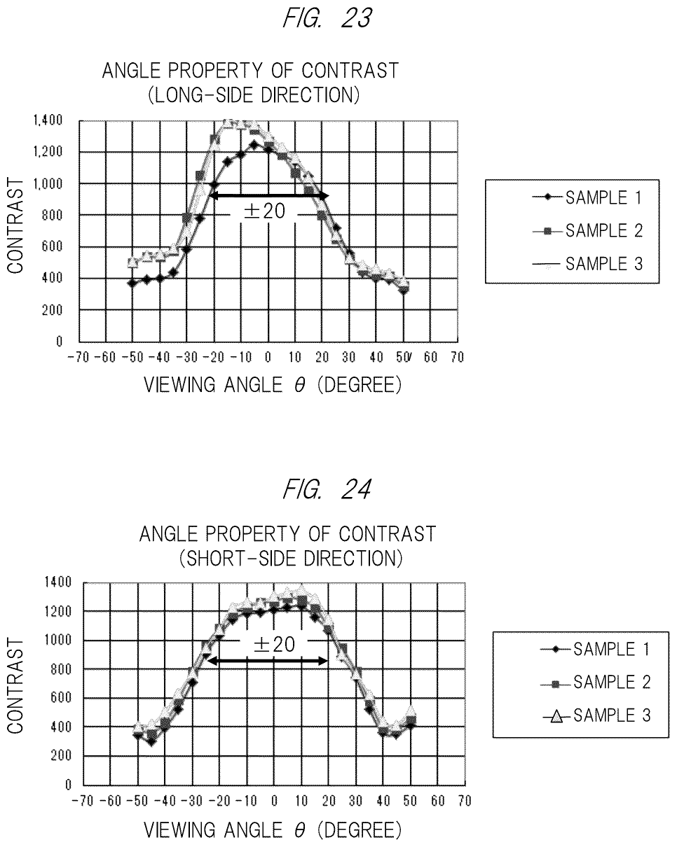

On the other hand, the contrast performance in the panel short-side (vertical) direction is excellent in a range of −15 degrees to +15 degrees as illustrated in FIG. 24, and its most excellent property along with the luminance property is provided under the use in a range of +10 degrees around 5 degrees.

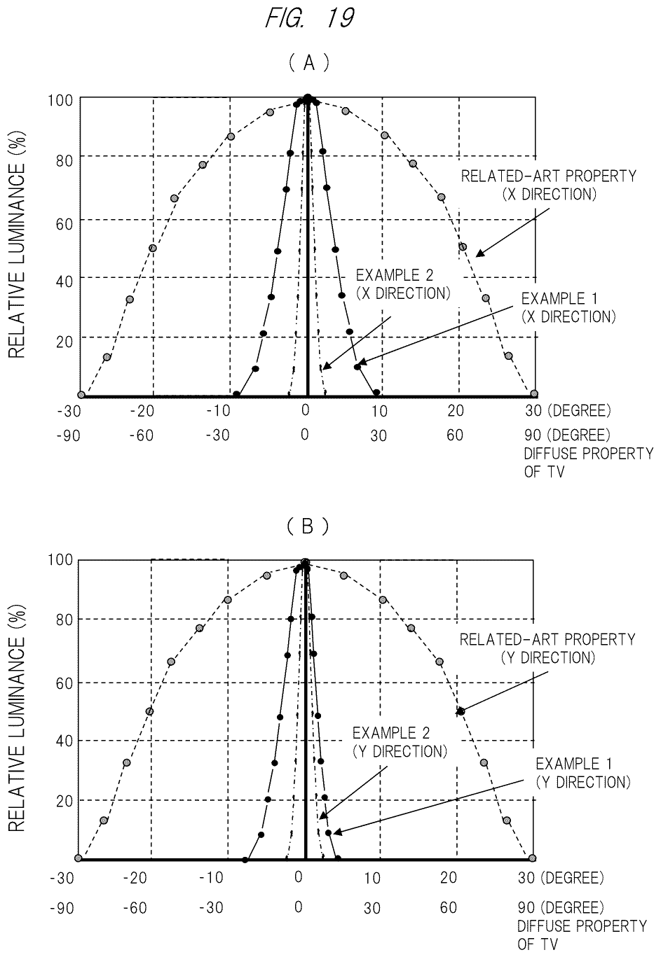

Further, the properties of the luminance and the viewing angle in the panel long-side (horizontal) direction are excellent at the emission angle orthogonal to the panel surface (the emission angle of 0 degree) as illustrated in FIG. 21. This is because the light twist property in the long-side (horizontal) direction of the liquid crystal panel is 0 degree at the maximum applied voltage.

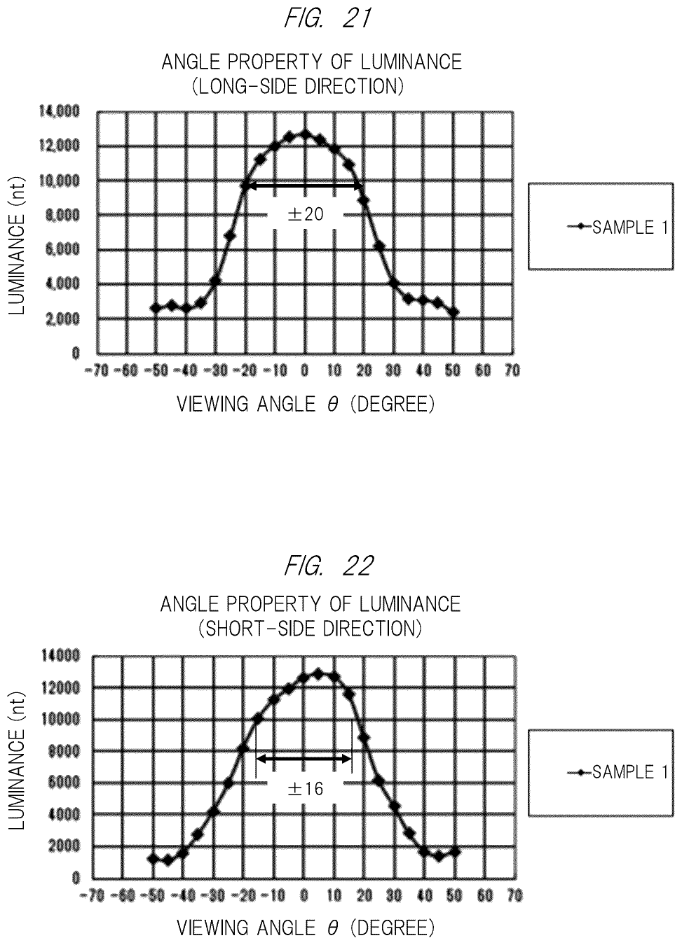

Similarly, the contrast performance in the panel long-side (horizontal) direction is excellent in a range of −5 degrees to −10 degrees as illustrated in FIG. 23, and its most excellent property along with the luminance property is provided under the use in a range of +5 degrees around −5 degrees. Thus, as the emission angle of the video light emitted from the liquid crystal panel, the light is made incident on the liquid crystal panel in a direction in which the most excellent property is achieved by a light-flux direction converter provided on the light guiding body of the light source 13, and is optically modulated by a video signal to improve the image quality and the performance of the video display 1.

When the incident light emitted from the light source into the liquid crystal panel is set in the above range in order to maximize the luminance and the contrast property of the liquid crystal panel serving as the video display element, the video quality of the air floating video can be improved.

### Method of Controlling Light-Source Light

In the present embodiment, in order to improve the use efficiency of the emission light flux emitted from the light source 13 to remarkably reduce the power consumption, the video light ray emitted from the light source 13 of the video display 1 including the light source 13 and the liquid crystal display panel 11 is made incident on the liquid crystal panel 11 at the incidence angle maximizing the property of the liquid crystal panel 11, and then, is modulated in terms of the luminance in accordance with the video signal, and is emitted toward the retroreflector. At this time, in order to downsize a volume of the air floating video display system set, it is desirable to increase a degree of freedom of arrangement of the liquid crystal panel 11 and the retroreflector. Further, the following technique is used for forming the floating video at a desired after the retroreflection to secure the optimum position directionality.

The video display surface of the liquid crystal panel 11 is provided with a transparent sheet made of the optical component such as the linear Fresnel lens as the light-direction converter panel, and therefore, the emission direction of the incident light flux toward the retroreflection optical member is controlled with high directionality to determine the image forming position of the air floating video. In this configuration, the video light emitted from the video display 1 efficiently reaches the viewer while having the high directionality (rectilinear propagation) as similar to laser beam. As a result, the high-quality floating video can be displayed at high resolution, and the power consumption based on the video display 1 including the light source 13 can be remarkably reduced.

### First Example of Video Display

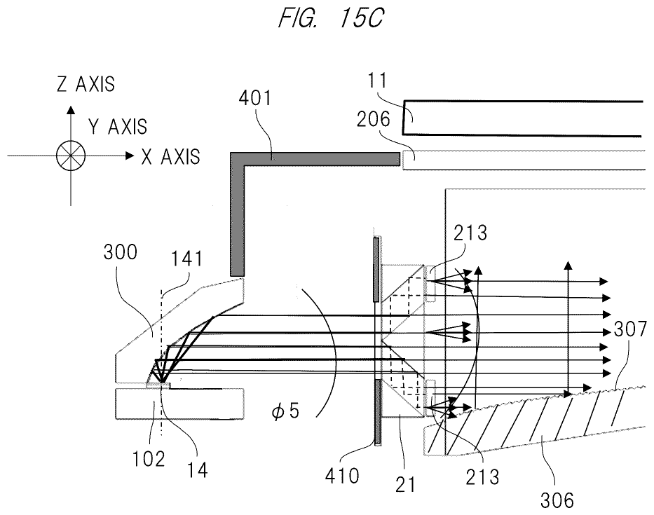

FIG. 16A illustrates another exemplary specific configuration of the video display 1. This light source 13 is configured such that an LED, a collimator, a composite (synthesis)/diffuse block, a light guiding body and the like are housed in a casing made of plastic or the like. The liquid crystal display panel 11 is attached onto an upper surface of the light source 13. An LED substrate on which a Light Emitting Diode (LED) element 14b that is a semiconductor light source and a control circuit for the LED element are mounted is attached to one side surface of the casing of the light source 13, and a heat sink (not illustrated) that is a member for cooling the heat generated in the LED element and the control circuit is attached to an outer surface of the LED substrate.

To a liquid crystal display panel frame attached to an upper surface of the casing, the liquid crystal display panel 11 attached to this frame, a flexible wiring substrate (Flexible Printed Circuit: FPC) (not illustrated) electrically connected to this liquid crystal display panel 11 and others are attached. In other words, the liquid crystal display panel 11 that is the liquid crystal display component generates the display video in corporation with the LED element 14b that is a solid light source by modulating an intensity of the transmission light on the basis of a control signal output from a control circuit (not illustrated here) configuring the electronic device.

### First Exemplary Light Source of First Exemplary Video Display

Subsequently, a configuration of the optical system such as the light source housed in the casing will be explained in detail with reference to FIG. 16B in addition to FIG. 16A. FIGS. 16A and 16B illustrate LEDs 14 and 14b configuring the light source, and each of them is attached to a predetermined position of the collimator 18. Note that each collimator 18 is made of, for example, a light-transmittable material such as glass or heat-resistant resin. As shown in FIG. 16B, the collimator 18 has a conically convex outer circumferential surface 156 formed by rotation of a paraboloid cross section, and has a concave portion 153 with a convex portion (in other words, a convex lens surface) 157 at center of its apex (a side in contact with the LED substrate).

A center of a plane portion (on an opposite side to the apex) of the collimator 18 has a convex lens surface 154 that protrudes outward (or may be a concave lens surface that is recessed inward). Note that the paraboloid surface 156 forming the conically-shaped outer circumferential surface of the collimator 18 is set at an angle range allowing the light peripherally emitted from the LEDs 14 and 14b to be internally totally reflected, or forming the reflection surface.

Each of the LED elements 14 and 14b is arranged at a predetermined position on the surface of the substrate 102. The substrate 102 is arranged and fixed so that each of the LEDs 14 and 14b on its surface is positioned at center of the concave portion 153 to correspond to the collimator 18.

In such a configuration, by the collimator 18, among the light emitted from the LED 14 or 14b, particularly the light emitted upward (in the right direction in the drawing) from its center is collected to form the substantially collimated light by the two convex lens surfaces 157 and 154 forming the outer shape of the collimator 18. The light peripherally emitted from other portions is reflected by the paraboloid surface forming the conically-shaped outer circumferential surface of the collimator 18, and is similarly collected to form the substantially collimated light. In other words, by the collimator 18 having the convex lens formed on its center and the paraboloid surface formed on the peripheral portion, almost all the light components generated by the LED 14 or 14b can be extracted as the collimated light. In this manner, the use efficiency of the generated light can be improved.

Note that a light emission region of the collimator 18 is provided with a polarization converter element 21. The polarization converter element 21 may be also referred to as polarization converter member. As clearly seen from FIG. 16B, the polarization converter element 21 is made of combination of a pillar-shaped light transmittable member having a parallelogram cross section (referred to as parallelogram pillar below) and a pillar-shaped light transmittable member having a triangle cross section (referred to as triangle pillar below), and a plurality of these members are arranged in an array form in parallel to a surface perpendicular to an optical axis of the collimated light emitted from the collimator 18. Further, a light-polarization beam splitter (abbreviated below as PBS film) and a reflection film are alternately arranged at a boundary between the adjacent light transmittable members that are arranged in the array form. The emission surface from which the light having entered the polarization converter element 21 and been transmitted through the PBS film is emitted includes a λ/2 waveplate.

### Directionality of Emission Light From Liquid Crystal Panel

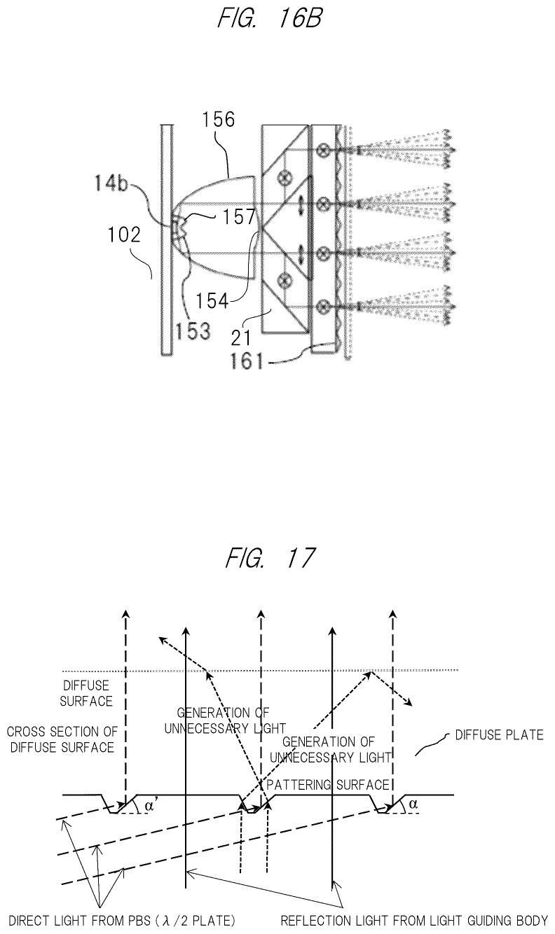

In a general apparatus for TV, the emission light emitted from the liquid crystal display panel 11 has the same diffuse property between a screen horizontal direction (display direction corresponding to an X axis in a graph of FIG. 19(A)) and a screen vertical direction (display direction corresponding to a Y axis in a graph of FIG. 19(B)) as illustrated in, for example, plot curves of “related-art property (X direction)” in FIG. 19(A) and “related-art property (Y direction) in FIG. 19(B).

On the other hand, the diffuse property of the light flux emitted from the liquid crystal display panel according to the present embodiment is as illustrated in, for example, plot curves of “Example 1 (X direction)” in FIG. 19(A) and “Example 1 (Y direction)” in FIG. 19(B).

In a specific example, if a viewing angle having a luminance that is 50% of a luminance (luminance reduced to be half) of front view (angle of 0 degree) is set to 13 degrees, this angle is about ⅕ of the diffuse property (62 angle degrees) of the apparatus for general household-use TV. Similarly, for example, if a viewing angle in the vertical (perpendicular) direction is set to unequal between the upper side and the lower side, a reflection angle of the reflection-type light guiding body, an area of the reflection surface and others are optimized so that the upper viewing angle is reduced (narrowed) to be about ⅓ of the lower viewing angle.

Since the viewing angles and the like are set as described above, an amount of the video light toward a user's viewing direction is remarkably made larger (is remarkably more improved in terms of brightness of the video) than that of the related-art liquid crystal TV, and the luminance of the video is more than 50 times.

Further, in a case of the viewing-angle property of the “Example 2” of FIG. 19, if a viewing angle having a luminance that is 50% of a luminance (luminance reduced to be half) of front view (angle of 0 degree) is set to 5 degrees, this angle is an angle of about 1/12 (narrow viewing angle) of the diffuse property (62 angle degrees) of the apparatus for general household-use TV. Similarly, for example, if a viewing angle in the vertical direction is set to unequal between the upper side and the lower side, a reflection angle of the reflection-type light guiding body, an area of the reflection surface and others are optimized so that the viewing angle in the vertical direction is reduced (narrowed) to be about 1/12 of the related-art viewing angle.

By such setting as described above, luminance (amount) of the video light toward the viewing direction (user's viewing direction) is remarkably more improved than that of the related-art liquid crystal TV, and the luminance of the video is more than 100 times.

As described above, since the viewing angle is the narrower viewing angle, the light flux toward the viewing direction can be concentrated to remarkably improve the light use efficiency. As a result, even if the general liquid crystal display panel for TV is used, when the light diffuse property of the light source is adjusted, the luminance can be remarkably improved at equivalent power consumption to achieve the video display for the display system for bright outdoors.

In use of a large liquid crystal display panel, when the light on the periphery of the screen is directed inward to propagate toward the viewer when the viewer faces the center of the screen, a full-screen performance in terms of the screen brightness is improved. Meanwhile, if a panel size (screen ratio (16:10)) of the video display is equal to or smaller than 5 inches while the panel is portrait-oriented (the screen of the liquid crystal display panel is used to be vertically long (also referred to as “vertically-long use” below)), the horizontal directionality may be set to the very narrow angle to provide the air floating video display apparatus achieving the high luminance or the low power consumption.

A plurality of examples will be explained below as another example of the light source. All such another examples of the light source may be applicable in place of the light source of the above-described example of the video display.

As described above, in use of the large liquid crystal display panel, when the light on the periphery of the screen is directed inward to propagate toward the viewer when the viewer faces the center of the screen, the full-screen performance in terms of the screen brightness is improved. On the other hand, binocular disparity is caused depending on viewing by either right or left eye of the viewer. Meanwhile, the smaller the panel size is, or, the smaller (closer) the viewing distance is, the larger the convergent angle in the binocular disparity using both right and left eye is. Particularly in use of a small panel of 7 inches or smaller, the convergent angle in the binocular disparity is an important factor. Therefore, the video light is designed to be directed in an optimum viewing range of the system by expansion in the light diffuse property or the directionality of the light source.

Further, depending on a required specification of the system, it is necessary to optimally design the shape, the surface roughness, the tilt, and the like of the reflection surface of the light guiding body of the light source 13 in order to achieve the horizontal and vertical directionality and the diffuse property.

### First Exemplary Light Source

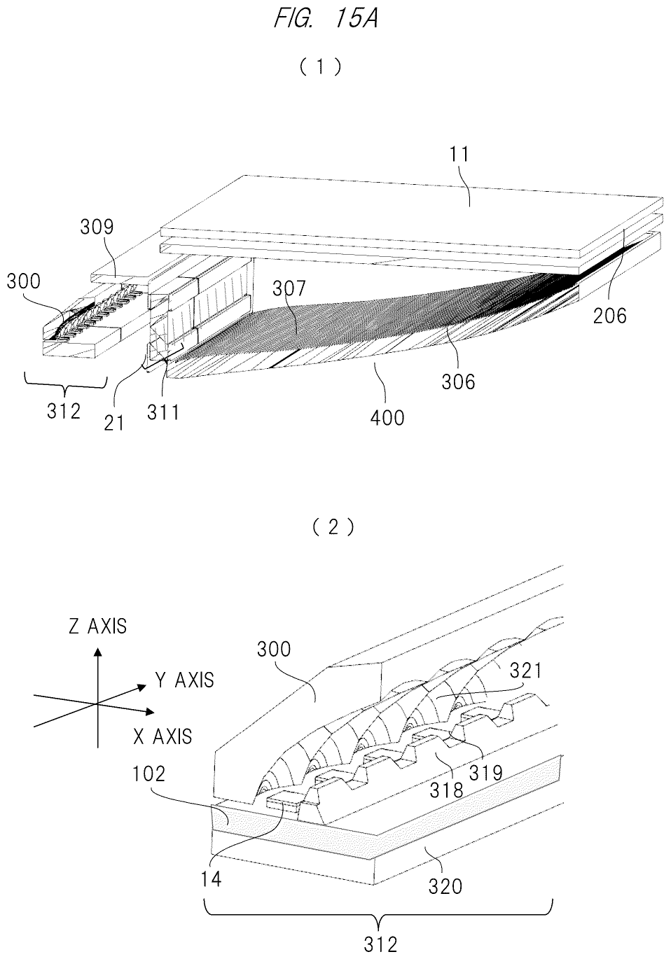

Next, with reference to FIG. 14, another exemplary light source will be explained. Each of FIGS. 14(a) and 14(b) is a diagram in which a part of the diffuse plate 206 and the liquid crystal display panel 11 is eliminated for explaining the light guiding body 311.

FIG. 14 shows a state of the substrate 102 provided with the LED 14 configuring the light source. The LED 14 and the substrate 102 are attached at predetermined positions to correspond to a reflector 300.

As shown in FIG. 14, the LEDs 14 are arranged on a line in parallel to the side (in this example, the short side) of the liquid crystal display panel 11 to be close to the arrangement of the reflector 300. In the illustrated example, the reflector 300 is arranged to correspond to the arrangement of the LED. Note that a plurality of the reflectors 300 may be arranged.

In a specific example, each reflector 300 is made of a plastic material. As another example, the reflector 300 may be made of a metal material or a glass material. However, since the plastic material is easier to be shaped, the plastic material is used in the present example.

As shown in FIG. 14(b), an inner (in the drawing, right) surface of the reflector 300 has a reflection surface (referred to as “paraboloid surface” below) 305 having a shape resulted from cut of a paraboloid surface at a meridional plane. In the reflector 300, the diffuse light emitted from the LED 14 is converted to the substantially collimated light by being reflected by the reflection surface 305 (paraboloid surface), and the converted light is caused to enter an end surface of the light guiding body 311. The reflection surface of the reflector 300 is designed to have a structure in which not only an aluminum reflection surface but also a plurality of metal films made of Ti, SiO or the like are deposited as high reflection coating films to enhance the reflectance and decrease the dependency of the incidence angle. In a specific example, the light guiding body 311 is a reflection-type light guiding body.

The reflection surface of the reflector 300 has a shape that is asymmetric across an optical axis of the light emitted from the LED 14. Since the reflection surface 321 of the reflector 300 is the paraboloid surface as described above, the reflected light flux is converted to the substantially collimated light when the LED is arranged at a focal point of this paraboloid surface.

The diffuse light emitted from the LED cannot be converted to the completely collimated light even when the LED 14 is arranged at the focal point of this paraboloid surface because the LED 14 is the surface-emitting light source. However, a performance of the light source of the present invention is not affected. The LED 14 and the reflector 300 are paired. The number of the attachment of the LEDs to the substrate should be equal to or smaller than 10 in order to secure a predetermined performance when accuracy of the attachment of the LEDs 14 to the substrate 102 is ±40 μm, and is better to be about 5 in consideration of mass productivity.

Although the LED 14 and the reflector 300 are partially close to each other, rise of a temperature of the LED can be reduced since the heat can be released to a space near an opening of the reflector 300. Therefore, the plastic-molded reflector 300 is applicable. As a result, according to this reflector 300, the shaping accuracy of the reflection surface can be improved to be equal to or higher than 10 times of that of the glass reflector, and therefore, the light use efficiency can be improved.

Meanwhile, as shown in FIG. 4, a base surface 303 of the light guiding body 311 is provided with a reflection surface, and the light emitted from the LED 14 is converted to the collimated light by the reflector 300, and then, is reflected by this reflection surface, and is emitted toward the liquid crystal display panel 11 facing the light guiding body 311. The reflection surface formed on the base surface 303 may have a plurality of surfaces that are different in a tilt from one another in the propagation direction of the collimated light flux emitted from the reflector 300 as shown in FIG. 14, and the light is reflected by each surface, and propagates toward the liquid crystal panel corresponding to each surface. Each surface of the plurality of surfaces that are different in the tilt from one another may have a shape extending in a direction perpendicular to the propagation direction of the collimated light flux emitted from the reflector 300.

As shown in FIG. 14, a shape of the reflection surface formed on the base surface 303 may be a flat shape. Further, a diffuse plate 206 may be arranged in order to more accurately control the diffuse property of the light reflected by the reflection surface formed on the base surface 303 of the light guiding body 311 facing the liquid crystal display panel 11. Because of the surface shape and the surface roughness, this diffuse plate can refract the reflection light once, and accurately adjust the light quantity and the diffuse direction of the light flux that propagates toward the liquid crystal display panel 11, and therefore, can similarly accurately control the light quantities and the emission directions of the incident light on the liquid crystal display panel 11 and the emission light emitted from the liquid crystal display panel 11. Therefore, in the air floating video display system using the video display 1, the diffuse direction and the diffuse angle of the video light of the air floating video can be set to desirable values. In this case, by addition of a high reflection coating film made of Ti, SiO or the like to the aluminum reflection surface on the reflection surface, the enhanced reflectance and the decreased dependency of the incidence angle may be designed. Since the reflectance of the aluminum reflection film in the blue-green wavelength band of 500 nm or lower is lower than its reflectance in the green-red wavelength band, white color purity is an important factor for the decreased dependency of the incidence angle and the improvement of the color reproduction in the design of the high reflection coating film.

As shown in FIG. 14, the LED 14 is soldered on a metallic substrate 102. Therefore, the heat generated in the LED can be released to air through the substrate. The reflector 300 may be in contact with the substrate 102 or be spaced from it. When the space is formed, the reflector 300 is arranged to be tightly close to the housing. By the formed space, the heat generated in the LED can be released to air, and the cooling effect is enhanced. As a result, an operation temperature of the LED can be lowered, and therefore, retention of the light emission efficiency and the long life can be achieved.

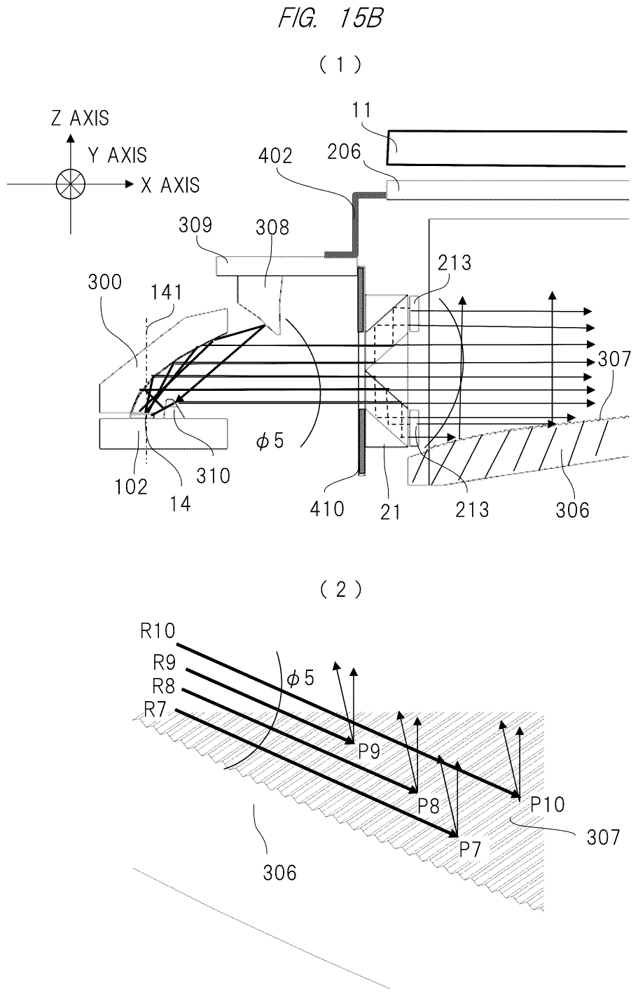

A light use efficiency is 1.8 times better under the usage of the polarization converter element 21 even in the light source. A configuration of an optical system regarding the light source will be explained in detail with reference to FIGS. 15A, 15B, 15C and 15D.

FIGS. 15A, 15B and 15C illustrate the state of the substrate 102 provided with the LED 14 configuring the light source, and a unit 312 is configured to include a plurality of blocks each made of a pair of the reflector 300 and the LED 14.

Among these members, a base member 320 shown in FIG. 15A(2) is a base member of the substrate 102. Generally, the metallic substrate 102 has heat, and therefore, the base member 320 may be made of a plastic material or the like in order to (thermally) insulate the heat of this substrate 102, or a metallic member for enhancing the heat release.

The reflection surface 321 of the reflector 300 may have a shape that is asymmetric across the optical axis of the light emitted from the LED 14. A reason for this will be explained with reference to FIG. 15A(2). In the present example, the reflection surface of the reflector 300 is the paraboloid surface, and the center of the light emission surface of the LED that is the surface-emitting light source is arranged at the focal position of the paraboloid surface.

And, because of the characteristics of the paraboloid surface, the light emitted from the four corners of the light emission surface also becomes the substantially collimated light flux, and is different in only the light emission direction. Therefore, even if the light emitting unit has an area, when a distance between the reflector 300 and the polarization converter element arranged at the subsequent stage is small, the light quantity and the conversion efficiency of the light entering the polarization converter element 21 are hardly affected.

And, even if the attachment position of the LED 14 shifts on an X-Y plane from the focal point of the corresponding reflector 300, the optical system capable of suppressing the reduction of the light conversion efficiency can be achieved because of the above-described reason. Further, even if the attachment position of the LED 14 varies in a Z-axis direction, only movement of the converted collimated light flux on a Z-X plane is needed, and therefore, the attachment precision requirement for the LED that is the surface-emitting light source can be significantly reduced. Also in the present example, the reflector 300 having the reflection surface resulted from cutting of a part of the paraboloid surface on a meridian has been explained. However, the LED may be arranged in a cut part of the entire paraboloid surface as the reflection surface.

On the other hand, as shown in FIGS. 15B(1) and 15C, the present example has a characteristic configuration in which the diffuse light emitted from the LED 14 is reflected and converted to the substantially collimated light by the paraboloid surface 321, and then, is caused to enter the end surface of the polarization converter element 21 at the subsequent stage, and is equalized to have the specific polarized wave by the polarization converter element 21. By such a characteristic configuration, the light use efficiency of the present invention is 1.8 times better than that of the example of FIG. 14, and the light source having high efficiency can be achieved.

In this case, note that all components of the substantially collimated light resulted from the reflection of the diffuse light emitted from the LED 14 by the paraboloid surface 321 are not equalized. Therefore, the angular distribution of the reflection light is adjusted by the reflection surface 307 having the plurality of tilts, and the light can be caused to enter the liquid crystal display panel 11 in the direction perpendicular to the liquid crystal display panel 11.

In the example of these drawings, the direction of the light (principal ray) entering the reflector from the LED and the direction of the light entering the liquid crystal display panel are arranged to be substantially parallel to each other. This arrangement is easily made in terms of the design, and arrangement of the thermal source below the light source is more preferable since the temperature increase of the LED can be decreased by the upward air release.

As shown in FIG. 15B(1), in order to improve a capture rate of the diffuse light emitted from the LED 14, the light flux incapable of being captured by the reflector 300 is reflected by the sub reflector 308 formed in a light shielding plate 309 above the reflector, is reflected by a tilt surface of a sub reflector 310 on a lower side, and is caused to enter an effective region of the polarization converter element 21 at the subsequent stage, and therefore, the light use efficiency is further improved. In other words, in the present example, a part of the light having been reflected by the reflector 300 is reflected by the sub reflector 308, and the light having been reflected by the sub reflector 308 is reflected toward the light guiding body 306 by the sub reflector 310.

By the reflection shape on the surface of the reflection-type light guiding body 306, the substantially collimated light flux having the specific polarized wave equalized by the polarization converter element 21 is reflected toward the liquid crystal display panel 11 facing the light guiding body 306. In this case, the light-quantity distribution of the light flux entering the liquid crystal display panel 11 is optimally designed by the shape and the arrangement of the reflector 300, and the reflection surface shape (cross-sectional shape), the reflection surface tilt and the surface roughness of the reflection-type light guiding body and others.

The plurality of reflection surfaces are arranged as the reflection surface shape formed on the surface of the light guiding body 306 to face the light emission surface of the polarization converter element 21 such that the tilt, the area, the height and the pitch of the reflection surface are optimized in accordance with the distance from the polarization converter element 21, and, as a result, the light-quantity distribution of the light flux entering the liquid crystal display panel 11 is designed to be a desirable value as described above.

The reflection light can be accurately adjusted when the reflection surface 307 formed on the reflection-type light guiding body 306 is configured to have one surface with the plurality of tilts as shown in FIG. 15B(2). As shown in FIG. 15B(2), each propagating direction of the collimated light fluxes 5 (R7 to R10) emitted from the reflector 300 propagates toward the corresponding liquid crystal panel after being reflected on each of the plurality of surfaces (P7 to P10) with the different tilts. In such a configuration of the reflection surface having one surface with the plurality of tilts, note that a region to be used as the reflection surface may be made of a plurality of surfaces, a polygonal surface or a curved surface. Further, the light-quantity distribution can be more equalized by a diffuse function of the diffuse plate 206. The light-quantity distribution of the light entering the diffuse plate closer to the LED can be equalized by change of the tilts of the reflection surface. As a result, the light quantity and the emission direction of the light flux that propagates toward the liquid crystal display panel 11 are accurately adjusted. As a result, the light quantities and the emission directions of the incident light on the liquid crystal display panel 11 and the emission light emitted from the liquid crystal display panel 11 can be similarly accurately adjusted. Therefore, in the air floating video display system using the video display 1, the diffuse direction and the diffuse angle of the video light of the air floating video can be set to desirable values.

In the present example, a plastic material such as heat-resistant polycarbonate is used for the base member of the reflection surface 307. An angle of the reflection surface 307 to which the light propagates immediately after the light emission from the λ/2 waveplate 213 is changed in accordance with a distance between the λ/2 waveplate and the reflection surface.

Also in the present example, although the LED 14 and the reflector 300 are partially close to each other, the heat can be released to the space near the opening of the reflector 300, and the temperature increase of the LED can be decreased. Alternatively, up-and-down arrangement order of the substrate 102 and the reflector 300 may be inversed from the arrangement of FIGS. 15A, 15B and 15C.

However, if the substrate 102 is arranged on the upper side, the substrate 102 is close to the liquid crystal display panel 11, and therefore, layout may be made difficult. Therefore, the arrangement of the substrate 102 on the lower side of the reflector 300 (to be farther from the liquid crystal display panel 11) as shown in the drawing makes the configuration in the apparatus simpler.

The light entering surface of the polarization converter element 21 may be provided with a light shielding plate 410 in order to prevent the unnecessary light from entering the optical system at the subsequent stage. By such a configuration, the light source in which the temperature increase is suppressed can be achieved. The light polarizer on the light entering surface of the liquid crystal display panel 11 can absorb the light flux having the equalized light polarization as described in the present invention to decrease the temperature increase, and the light polarizer on the entering side can absorb a part of the light having the light polarization direction rotated when being reflected by the reflection-type light guiding body. The temperature of the liquid crystal display panel 11 is also increased by the temperature increase due to the absorption in the liquid crystals themselves and the light entering the electrode pattern. However, since there is the sufficient space between the liquid crystal display panel 11 and the reflection surface of the reflection-type light guiding body 306, the liquid crystal display panel 11 can be naturally cooled.

FIG. 15D shows a modification example of the light source of FIGS. 15B(1) and 15C. FIG. 15D(1) shows a modification example of an extracted part of the light source of FIG. 15B(1). Configurations of other components are the same as those of the light source of FIG. 15B(1), and therefore, illustration and repetitive explanation of the same will be omitted.

First, in the example shown in FIG. 15D(1), a height of a concave portion 319 of the sub reflector 310 is adjusted to be lower than a phosphor (fluorescent body) 114 so that fluorescence principal ray (see a straight line extending in a direction parallel to the X-axis in FIG. 15D(1)) emitted in the horizontal direction (X-axis direction) from the phosphor 114 is released out of the concave portion 319 of the sub reflector 310. Further, a height of a light shielding plate 410 in the Z-axis direction is adjusted to be lower than the position of the phosphor 114 so that the fluorescence principal ray emitted in the horizontal direction from the phosphor 114 is not shielded by the light shielding plate 410 and enters the effective region of the polarization converter element 21.

The reflection surface of the convex portion of convex and concave on the apex of the sub reflector 310 reflects the light having been reflected by the sub reflector 308 in order to guide the light having been reflected by the sub reflector 308 toward the light guiding body 306. Therefore, a height of a convex portion 318 of the sub reflector 310 is adjusted so that the light having been reflected by the sub reflector 308 is reflected and is caused to enter the effective region of the polarization converter element 21 at the subsequent stage, and, as a result, the light use efficiency can be further improved.

Note that the sub reflector 310 is arranged to extend in one direction as shown in FIG. 15A(2), and has the convex and concave shape. On the apex of the sub reflector 310, convex and concave having one or more concave portions 319 and convex portions 318 are periodically arranged in one direction. Such a convex and concave shape achieves the configuration in which the fluorescence principal ray emitted in the horizontal direction from the phosphor 114 enters the effective region of the polarization converter element 21.

The convex and concave shape of the sub reflector 310 is periodically arranged at a pitch at which the concave portion 319 is positioned at the LED 14. In other words, each phosphor 114 is periodically arranged in one direction to correspond to the pitch of the arrangement of the concave portion of the convex and concave of the sub reflector 310. If the LED 14 includes the phosphor 114, note that the phosphor 114 may be interpreted as the light emitter portion of the light source.

FIG. 15D(2) shows a modification example of an extracted part of the light source of FIG. 15C. Configurations of other components are the same as those of the light source of FIG. 15C, and therefore, illustration and repetitive explanation of the same will be omitted. As shown in FIG. 15D(2), the sub reflector 310 may be eliminated. However, as similar to FIG. 15D(1), the height of the light shielding plate 410 in the Z-axis direction is adjusted to be lower than the position of the phosphor 114 so that the fluorescence principal ray emitted in the horizontal direction from the phosphor 114 is not shielded by the light shielding plate 410 and enters the effective region of the polarization converter element 21.

In the light sources of FIGS. 15A, 15B, 15C and 15D, note that a sidewall 400 may be formed as shown in FIG. 15A(1) in order to prevent dusts from entering the space between the liquid crystal display panel 11 and the reflection surface of the reflection-type light guiding body 306, prevent stray light toward outside of the light source and prevent stray light from entering from the outside of the light source. When the sidewall 400 is formed, the sidewall 400 is arranged to sandwich a space between the light guiding body 306 and the diffuse plate 206.

The light emission surface of the polarization converter element 21 that emits the light having been converted in terms of the light polarization by this polarization converter element 21 faces a space surrounded by the sidewall 400, the light guiding body 306, the diffuse plate 206 and the polarization converter element 21. A reflection surface having a reflection film or others is used as a surface of inner surfaces of the sidewall 400, the surface covering, from a side surface, a space in which the light is emitted from the light emission surface of the polarization converter element 21 (the space is a right space of the light emission surface of the polarization converter element 21 of FIG. 15B(1)). In other words, the surface of the sidewall 400 facing this space has the reflection region having the reflection film. Since this portion of the inner surfaces of the sidewall 400 is used as the reflection surface, the light having been reflected by this reflection surface can be reused as the light of the light source, and the luminance of the light source can be improved.

The surface of the inner surfaces of the sidewall 400, the surface covering the polarization converter element 21 from the side surface, is formed as a surface e having a low light reflectance (such as a black surface without the reflection film or others). This is because the reflection light on the side surface of the polarization converter element 21 generates the light having the unexpected light polarization state to be a cause of the stray light. In other words, when the surface is formed as the surface having the low light reflectance, the generation of the stray light of the video and the light having the unexpected light polarization state can be prevented or suppressed. Alternatively, a part of the sidewall 400 may be configured to have an air-flow hole to improve the cooling effect.

Note that the configuration using the polarization converter element 21 is a prerequisite on the explanation for the light sources of FIGS. 15A, 15B, 15C and 15D. However, a configuration in which the polarization converter element 21 is eliminated from such a light source is also applicable. In this case, such a light source can be provided at a less cost.

### Another Second Exemplary Light Source

Subsequently, a configuration of an optical system regarding a light source using the reflection-type light guiding body 304 based on the light source shown as the first exemplary light source will be explained in detail with reference to FIGS. 16A(1), (2) and (3) and 8B.

FIG. 16A shows a state of the substrate 102 provided with the LED 14 configuring the light source, and a unit 328 is configured to include a plurality of blocks each made of a pair of the collimator 18 and the LED 14. Since the collimator 18 of the present example is close to the LED 14, the glass material is used in consideration of the thermal resistance. And, the light shielding plate 317 is arranged at a previous stage of the entering to the polarization converter element 21, and, as a result, the unnecessary light is prevented or suppressed from entering the optical system at a subsequent stage, and the temperature increase due to the unnecessary light is decreased.

Since other configurations and effects of the light source shown in FIG. 16A are the same as those of FIGS. 15A, 15B, 15C and 15D, the repetitive explanation thereof will be omitted. In the light source shown in FIG. 16A, a sidewall may be formed as similar to those explained in FIGS. 15A, 15B and 15C. A configuration and an effect of the sidewall has been already explained, and therefore, the repetitive explanation thereof will be omitted.

FIG. 16B is a cross-sectional view of FIG. 16A(2). A configuration of a light source shown in FIG. 16B has been already explained in the chapter <First Exemplary Light Source of First Exemplary Video Display>, and therefore, the repetitive explanation thereof will be omitted.

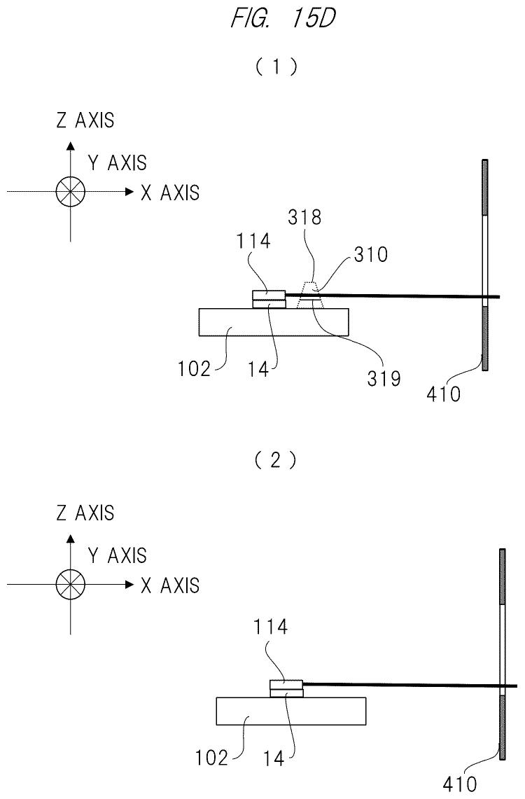

FIG. 17 is a cross-sectional view showing one example of a shape of the diffuse plate 206. As described above, the diffuse light emitted from the LED is converted to the substantially collimated light by the reflector 300 or the collimator 18, and is converted to have the specific polarized wave by the polarization converter element 21, and then, is reflected by the light guiding body. Then, the light flux having been reflected by the light guiding body is transmitted through a plane portion of a light entering surface of the diffuse plate 206, and enters the liquid crystal display panel 11 (see two solid-line arrows indicating “the reflection light emitted from the light guiding body” in FIG. 17).

The diffuse light flux of the light having been emitted from the polarization converter element 21 is totally reflected by a tilt surface of a protrusion having a tilt surface formed on the light entering surface of the diffuse plate 206, and enters the liquid crystal display panel 11. For the total reflection of the light having been emitted from the polarization converter element 21 by the tilt surface of the protrusion of the diffuse plate 206, an angle of the tilt surface of the protrusion is changed in accordance with the distance from the polarization converter element 21. When an angle of the tilt surface of the protrusion far from the polarization converter element 21 or far from the LED is set to “α” while an angle of the tilt surface of the protrusion close to the polarization converter element 21 or close to the LED is set to “α′”, α is smaller than α′ (α<α′). By such setting, the light flux having been converted in terms of the light polarization can be effectively used.

### Technique of Controlling Diffuse Property of Video Display

As a method of adjusting the diffuse distribution of the video light emitted from the liquid crystal display panel 11, optimization of a shape of a lenticular lens arranged between the light source 13 and the liquid crystal display panel 11 or on the surface of the liquid crystal display panel 11 is exemplified. In other words, by the optimization of the shape of the lenticular lens, the light emission property of the video light (also referred to as “video light flux” below) unidirectionally emitted from the liquid crystal display panel 11 can be adjusted.

A micro lens array in a matrix form may be alternatively or additionally arranged on the surface of the liquid crystal display panel 11 (or between the light source 13 and the liquid crystal display panel 11) to adjust an aspect of the arrangement. In other words, by the adjustment of the arrangement of the micro lens array, the light emission property of the video light flux emitted from the video display 1 in the X-axis direction and the

Y-axis direction can be adjusted, and, as a result, a video display having the desirable diffuse property can be provided.

As another configuration example, combination of two lenticular lenses may be arranged, or a sheet in which the micro lens array in the matrix form is arranged for adjusting the diffuse property may be arranged at a position at which the video light emitted from the video display 1 passes. By such an optical system configuration, a luminance (relative luminance) of the video light in the X-axis direction and the Y-axis direction can be adjusted in accordance with the reflection angle of the video light (the reflection angle provided when the reflection in the vertical direction is set to a criterion (0 degree)).

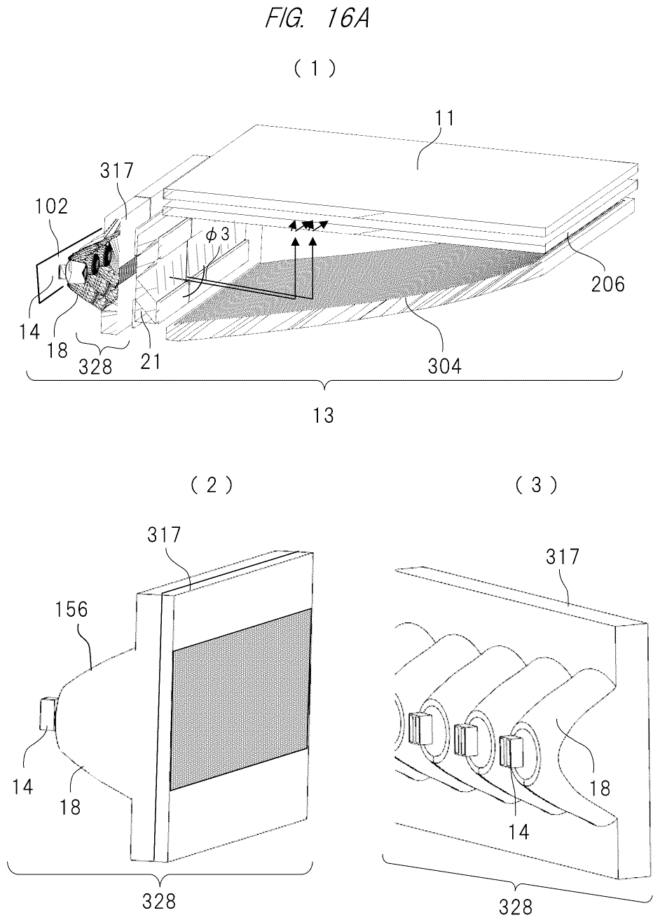

Because of use of such a lenticular lens, the present example can provide the excellent optical property as shown with the graph (plot curve) of “the Example 1 (Y-axis direction)” and “the Example 2 (Y-axis direction)” in FIG. 18(B) that is clearly different from the graph (plot curve) of the related-art property. Specifically, in the plot curve of “the Example 1 (Y-axis direction)” and “the Example 2 (Y-axis direction)”, the luminance property in the vertical direction is made sharp, and the balance of the directionality of the up and down directions (the positive and negative directions in the Y-axis direction) is changed, and, as a result, the luminance (relative luminance) of the light due to the reflection and the diffuse can be increased.

Therefore, the present example can provide the video light having the narrow diffuse angle (high rectilinear propagation) and only the specific polarized wave component as similar to the video light emitted from the surface-emitting light laser video source, can suppress the ghost image generated in the retroreflector in the case of the use of the video display of the related art, and can adjust the light so that the air floating video generated by the retroreflection efficiently reaches the eyes of the viewer.

By the light source, the diffuse property (referred to as “related-art property” in the drawings) of the light emitted from the general liquid crystal display panel as shown in FIGS. 19(A) and (B) can be provided with the directionality having the significantly narrow angle in both the X-axis direction and the Y-axis direction. The present example can provide such directionality having the narrow angle, and therefore, can achieve the video display emitting the nearly collimated video light flux in the specific direction and emitting the light with the specific polarized wave.

FIG. 18 shows one example of the property of the lenticular lens applied to the present example. In this example, the property in the X-axis direction (vertical direction) with respect to the Z-axis direction is particularly exemplified, and a property “O” indicates a luminance property having a peak of the light emission direction at an angle that shifts upward by nearly 30 degrees from the vertical direction (0 degree) and being symmetric in the up-and-down direction. Plot curves of a property “A” and a property “B” shown in the graph of FIG. 18 indicate property examples in which the luminance (relative luminance) is increased by collection of the upper video light of the peak luminance at nearly 30 degrees. Therefore, in these properties A and B, as seen from the comparison with the plot curve of the property O, the luminance (relative luminance) of the light is rapidly decreased in a region of an angle (θ>30°) where the tilt (angle θ) from the Z-axis direction toward the X direction exceeds 30 degrees.

In other words, according to the optical system including the lenticular lens, when the video light flux emitted from the image display 1 is caused to enter the retroreflector, the light emission angle and the viewing angle of the video light having the equalized narrow angle by the light source 13 can be adjusted, and the degree of freedom of the layout of the retroreflection sheet can be significantly improved. As a result, the degree of freedom regarding the image forming position of the air floating video formed at the desirable position after being reflected by or transmitted through the window glass can be significantly improved. As a result, the light serving as the light having the narrow diffuse angle (high rectilinear propagation) and having only the specific polarized wave component can efficiently reach the eyes of the viewer outside or inside the room. Therefore, even if the intensity (luminance) of the video light emitted from the video display 1 is decreased, the viewer can correctly recognize the video light and obtain the information. In other words, the display system having the low power consumption can be achieved because of the small output of the video display 1.

In the foregoing, various embodiments or examples (that are specific examples) to which the present invention is applied have been concretely described. Meanwhile, the present invention is not limited to the foregoing embodiments (specific examples), and includes various modification examples. In the above-described embodiments, for example, the entire system has been explained in detail for easily understanding the present invention, and the above-described embodiments do not always include all components explained above. Also, a part of the structure of one embodiment can be replaced with the structure of another embodiment, and besides, the structure of another embodiment can be added to the structure of one embodiment. Further, another structure can be added to/eliminated from/replaced with a part of the structure of each embodiment.

The light source described above is also applicable to not only the air floating video display apparatus but also a display apparatus such as HUD, tablet, and digital signage.

In the techniques according to the present embodiments, the air floating video is displayed in a state where the high-resolution and high-luminance video is aerially floated, and, as a result, for example, the user can perform operations without concern about contact infection in illness. When the techniques according to the present embodiments are applied to the system that is used by a large number of unspecified users, a contactless user interface having the less risk of the contact infection in illness and being available without the concern can be provided. The present invention providing such a technique contributes to “the third goal: Good Health and Well-being (for all people)” of the sustainable development goals (SDGs) advocated by the United Nations.

And, since only the normal reflection light is efficiently reflected with respect to the retroreflector by the techniques according to the present embodiments of making the diffuse angle of the emitted video light small and making the equalized specific polarized wave, the light use efficiency is high, and the bright and clear air floating video can be provided. The techniques according to the present embodiments can provide a contactless user interface being excellent in availability and capable of significantly reducing the power consumption. The present invention providing such a technique contributes to “the ninth goal: Industry, Innovation and Infrastructure” and “the eleventh goal: Sustainable Cities and Communities” of the sustainable development goals (SDGs) advocated by the United Nations.

Further, the techniques according to the present embodiments can form the air floating video made of the video light having the high directionality (rectilinear propagation). In the techniques according to the present examples, even in case of display of the video that requires the high security in an ATM at bank, a ticketing machine at station and so forth or display of the video having high confidentiality that needs to be confidential to a person who faces the user, the display of the video light having the high directionality can provide a contactless user interface having the less risk of the peek at the air floating video by the person different from the user. The present invention provides the above-described techniques, and therefore, contributes to “the eleventh goal: Sustainable Cities and Communities” of the sustainable development goals (SDGs) advocated by the United Nations.

### EXPLANATION OF REFERENCE CHARACTERS

1 . . . video display, 2 . . . transmission-type retroreflector, 3 . . . air image (air floating image), 3a and 3b . . . ghost image, 100 . . . light transmittable plate, 13 . . . light source, 250 . . . light control sheet, 251 . . . circuit board, 249. FPC, 252 . . . flame structure, 256 . . . power supply (mobile battery), 253 . . . housing, 254 . . . hinge (rotary mechanism), 102 . . . substrate, 11 . . . liquid crystal display panel, 206 . . . diffuse plate, 21 . . . polarization converter element, 300 . . . reflector, 213 . . . λ/2 waveplate, 306 . . . reflection-type light guiding body, 308 and 310 . . . sub-reflector

1. An air floating video display apparatus comprising:
a housing holding a display panel and a light source;
a power supply including a power source and being joined with the housing through a first joint; and
a flame structure holding a retroreflector movably joined with the housing through a second joint.

2. The air floating video display apparatus according to claim 1,
wherein the housing and the power supply are movably joined with each other through the first joint.

3. The air floating video display apparatus according to claim 1,
wherein the retroreflector is a transmission-type retroreflector.

4. An air floating video display apparatus comprising:
a housing holding a display panel and a light source;
a power supply including a power source and being joined with the housing through a first joint;
a transparent member joined with the power supply through a second joint; and
a retroreflector arranged above the power supply.

5. The air floating video display apparatus according to claim 4,
wherein the housing and the power supply are movably joined with each other through the first joint, and
the power supply and the transparent member are movably joined with each other through the second joint.

6. The air floating video display apparatus according to claim 4,
wherein the retroreflector is a reflection-type retroreflector.

7. An air floating video display apparatus comprising:
a display panel displaying a video and a light source housed in a housing; and
a structure in which a retroreflector reflecting video light emitted from the display panel and causing the reflected light to aerially display an air floating video of a real image is held by a flame structure;
wherein the flame structure and the housing are joined with each other by a connecting portion, and
a relative angle between the retroreflector and the display panel housed in the housing is optionally set.

8. The air floating video display apparatus according to claim 7,
wherein the housing and a power supply are joined with each other by a connecting portion, and
a power for driving the display panel and the light source is supplied from the power supply.

9. The air floating video display apparatus according to claim 7,
wherein one end of the flame structure is joined with the housing by a connecting portion, and
the other end of the housing is joined with a power supply by a connecting portion.

10, The air floating video display apparatus according to claim 7,
wherein an image forming position of the air floating video is changeable by setting of an angle of the flame structure to an optional angle with respect to the housing serving as a placement surface.

11. The air floating video display apparatus according to claim 7,
wherein a video light control sheet for controlling a diffuse property of video light is provided on a video display surface of the display panel,
the video light control sheet is arranged between the retroreflector and the display panel, and
the video light control sheet is a viewing-angle control film of the display panel.

12. The air floating video display apparatus according to claim 1,
wherein a diffuse angle and a diffuse direction of video light flux diffused from an air floating video are adjusted by a video light control sheet and a diffuse property of the light source.

13. The air floating video display apparatus according to claim 7,
wherein the light source includes:
a point-emitting or surface-emitting light source;
a reflector reflecting light emitted from the light source; and
a light guiding body guiding light emitted from the reflector toward the display panel, and
a reflection surface of the reflector has an asymmetric shape across an optical axis of the light emitted from the light source.

14. The air floating video display apparatus according to claim 13,
wherein the light guiding body is a reflection-type light guiding body.

15. The air floating video display apparatus according to claim 13,
wherein a plastic material, a glass material or a metal material is used for the reflector.

16. An air floating video display apparatus comprising:
a display panel displaying a video and a light source of the display panel housed in a housing; and
a structure in which a transmission-type retroreflector reflecting video light emitted from the display panel and causing the reflected light to aerially display an air floating video of a real image is held by a flame structure;
wherein the flame structure and the housing are joined with each other by a connecting portion,
a relative angle between the transmission-type retroreflector and the display panel housed in the housing is optionally set,
the housing and the power supply are joined with each other by a connecting portion, and
a housing structured is achieved such that the power supply is arranged to be substantially perpendicular to the housing in display of the air floating video to shield external light entering the transmission-type retroreflector.

17. An air floating video display apparatus comprising:
a display panel displaying a video and a light source of the display panel housed in a housing; and
a structure in which a retroreflector reflecting video light emitted from the display panel and causing the reflected light to aerially display an air floating video of a real image is held by a flame structure;
wherein the flame structure and the housing are joined with each other by a connecting portion,
a relative angle between the retroreflector and the display panel housed in the housing is optionally set,
the housing and the power supply are joined with each other by a hinge, and
the portable structure is achieved by folding the power supply and the housing to be along the flame structure.

18. An air floating video display apparatus comprising:
a transparent member;
a housing configured to house a display panel and a light source, and movably joined with the transparent member through a second joint;
a retroreflector configured to reflect light emitted from the display panel housed in the housing toward the transparent member; and
a power supply including a power source,
wherein the retroreflector is arranged between the housing and the power supply.
